(19) United States
(12) Patent Application Publication
(10) Pub. No.: US 2014/0058801 A1
(43) Pub. Date: Feb. 27, 2014

(54) System And Method To Measure, Aggregate And Analyze Exact Effort And Time Productivity

(71) Applicant: Sapience Analytics Private Limited, Pune (IN)

(72) Inventors: Shirish Prabhakar Deodhar, Pune (IN); Swati Shirish Deodhar, Pune (IN); Madhukar Sharan Bhatia, Pune (IN)

(73) Assignee: Sapience Analytics Private Limited, Pune (IN)

(21) Appl. No.: 13/975,912

(22) Filed: Aug. 26, 2013

Related U.S. Application Data
(63) Continuation-in-part of application No. 13/151,889, filed on Jun. 2, 2011.

(30) Foreign Application Priority Data
Jun. 4, 2010 (IN) 1722/MUM/2010

(51) Int. Cl. G06Q 10/06

(52) U.S. Cl. CPC G06Q 10/0639
USPC 705/7.38

(57) ABSTRACT

A system and method for automatically measuring, analyzing and improving exact work effort of white collar employees, without requiring manual intervention or configuration, is described. The system captures all the work effort put on by the users. Systems and methods have been described to track the daily time spent by employees, irrespective of whether the time is spent on one or more computing devices, or away from any computing system while in meetings, discussions, calls, lab work, outside travel, and remote visits. This is mapped to activities and objectives that are automatically inferred based on the applications and artifacts being used, the source of offline time usage, and the employee's position in the organization and role therein. The captured individual work effort is mapped to the organization's hierarchy and business attributes. As a result, work patterns and trends within each sub-unit/operational dimension of the business are identified.

This application is a continuation-in-part (CIP) of U.S. patent application Ser. No. 13/151,889 filed on Feb. 6, 2011, whose contents are incorporated by reference, herein.

### FIELD OF THE DISCLOSURE

The present disclosure relates to the field of effort and time productivity measurement for improving work force efficiency. Particularly, the present disclosure relates to the field of automated measurement, analysis and improvement of exact effort spent on business related activities and objectives, without requiring manual intervention or configuration.

### DEFINITION OF TERMS USED IN THIS SPECIFICATION

The term ‘Computing System’ (hereafter referred to as ‘CS’) in this specification relates to any computing machine that the user spends time on, and which has some connectivity to the Internet, for instance, desktops, laptops, remote desktops and Servers, electronic notebooks, tablets, personal digital assistants (PDAs), and smart phones.

The term ‘Presence Device’ (hereafter referred to as ‘PD’) in this specification relates to any system that identifies the time spent by the user away from any computing device for activities such as calls, travel, lab work, meetings, discussions, and remote visits. Example of PDs are calendaring tools that track scheduled meetings, swipe cards and biometric devices that identify work areas, EPABX and VOIP and mobile phones that record time spent by user on calls, standalone and smartphone based GPS and indoor location and positioning systems that indicate user presence when traveling, cameras and devices that recognize users through optical matching and so on.

The term ‘Presence Device Server’ (hereafter referred to as ‘PD servers’) in this specification relates to a Server that collects information from one or more types of PDs, and are capable of providing consolidated data regarding PDs and their access or usage by various individuals over a network connection and established protocol.

The term ‘artifact’ in this specification relates to folders, documents, files, web links and the like, accessed and used by an employee for performing a particular task on a Computing System (CS).

The term ‘application’ in this specification relates to preloaded applications on the CS, or web based applications hosted on a remote server, or initiated on a remote server from the CS. These applications can be for design, development, engineering, documentation, communication, browsing, emails, electronic chat, games, and any other purpose related to work or for personal use.

The term ‘online time’ in this specification relates to active user time spent on a Computing System (CS), and which is tracked directly on the user's CS or another CS to which the user is remotely connected.

The term ‘offline time’ in this specification relates to time spent away from any Computing System (CS), which is tracked separately through information sourced from calendaring tools, Presence Devices (PDs) and PD servers, or is identified manually by the employee.

The term ‘Activity’ in this specification relates to the nature of work on which time is spent by an employee towards achieving the assigned objectives. The list of activities is determined by the organization based on its business. For instance, Activity can include online ones like design, programming, testing, documentation, communication, and offline ones such as meetings, calls, lab work, travel, and visits.

The term ‘Purpose’ in this specification relates to the specific end objective on which the employee spent time on. This can be the work being done on an assigned project or function for the organization, initiatives (for example, innovation and certifications), non-project but company work, or it could be ‘Private’. All non-work related personal time is assigned to ‘Private’. Details of ‘Private’ time are not normally available to the organization (unless the organization and individual are agreed that this time during work hours will be visible as well).

Both ‘Activity’ and ‘Purpose’ can be multi-level so that they can cater to the diverse requirements across different parts of the business. Time utilization for an individual employee can get allocated only to Activities and Purposes that are applicable for that individual as per the role and position in the organization.

The term ‘Work Patterns’ in this specification relates to all the different characteristics of the work effort that are covered by this disclosure, including but not limited to, hourly and daily work time, time spent on specific Applications, Artifacts, Activities, Purposes, Computing Systems, online and offline time, and other derived information such as working in shifts, work week and weekly holidays, vacations taken, time on desk work and travel oriented function, uninterrupted work focus on important activities, breaks taken, completed work units, work-life balance and so on.

The term ‘organization sub-units’ in this specification relates to the entire organization or any part thereof, including business units, projects, teams, locations, and individual employees.

The term ‘per-employee Daily Average Work Patterns’ in this specification relates to a computed value for a particular organization sub-unit across a specified time range (from a start to end date), obtained by aggregating the Work Patterns for each user belonging to the sub-unit on each day, and determining a weighted average after inferring the valid working days for each user during the specified time range.

These definitions are in addition to those expressed in the art.

### BACKGROUND AND PRIOR ART

Exact work effort determination by an organization is crucial for establishing the efficiency baseline and then making improvements. The consequent ability to effect productivity improvements and optimize capacity utilization has a direct and significant impact on revenue, profitability and improved customer satisfaction.

Typically, manufacturing industries can easily measure productivity because the output is in terms of tangible parts or products manufactured each day or week. Further, work done by employees in the manufacturing industries is visible and measurable. However, it is very difficult to pin-point exact work effort at companies where employees fall into one or both of these categories: a) working mostly on computers to deliver products and services, and b) regularly travelling within and outside the office for sales, support and marketing. For example, in a typical Information Technology (IT) company, employees do most of their work on computers, and also attend to business meetings and calls. They may also perform some office related work on their laptops and smartphones while at home, on weekends and holidays, and while traveling. In office, employees spend some time on non-work related activities such as lunch and coffee breaks, smoke breaks, social chat etc. They may also use their computers for private online chat, emails and browsing. Besides office workers, organizations have marketing and sales staff who are on the phone and travel extensively for business, and whose work time is equally difficult to track. Hence, in most white collar jobs, whether desk bound or sales oriented, it is not possible to measure the exact time on actual work put in by employees.

An even bigger challenge is accounting for an employee's work time breakup across various Activities and end objectives (Purposes). The Activities may include online activities like design, programming, testing, documentation, communication, and offline ones such as meetings, calls, lab work, travel, and visits. Further, the Purposes can include objectives such as projects, product releases, functions (for example, recruitment and training) and initiatives (for example, innovation and certifications). Further, the Activity and Purpose lists can be single-level lists or multi-level hierarchical list, the latter allowing a fine-grained analysis of effort.

The lack of visibility into exact effort is exacerbated with recent trends towards flexible working hours, use of multiple and different types of computing systems (such as PC at work and home, smartphones, tablets) by each employee, teams at distributed locations, outsourcing to contractors and vendor teams, and policies that permit work from home. It is even more difficult to measure the work effort of sales and marketing staff who spend much of the work day on business calls, travel to customer locations, and discussions with clients. What is required is the means to capture all the user's work effort which in today's environment may be at any time during the day (24 hours) and week (7 days), on one or more computing systems, when at their desk or in travel and away from office.

Most managers do not want to micro-manage and track each user's daily work effort. They require objective metrics at team level that enable them to benchmark and suggest improvements to their staff. Manager guidance coupled with employee self-improvement is the preferred approach for greater productivity and optimizing collective effort across the organizational hierarchy and every business attribute such as roles, skills, verticals, technologies, cost and profit centers. Since employee privacy is important and may need to meet legal requirements in various countries where the organization operates, it should be possible to collect only work related effort, perhaps limiting visibility for managers only to team data.

Due to the absence of exact effort data, professional organizations focus primarily on measuring the outcome. Managers can only track the status of deliverables and tasks by doing periodic reviews and using standard project management techniques. When the outcome is not at desired level or delivered on time, then various reactive measures are attempted through more executive attention such as exerting pressure to work harder, improving delivery and management processes, and change in personnel.

Even when deliverables are on time and up to the required quality, it is difficult to assess whether there is room for effort improvement, which can lead to better financial results. For example, a project that is meeting its goals but with only 60% utilization of available capacity, can continue to do so with 30% less staffing. The profitability can be doubled on this already successful project. In contrast, if a project is not performing well, it would be useful to know whether this is due to poor effort or despite significant effort. The corrective actions required are very different in these two cases.

Typically, organizations depend on supervisors to interact regularly with employees for managing immediate tasks and achieving short term results. However, supervisors of a white collar workforce are constrained because of lack of any factual data about time and nature of actual work being done on computers, at phone, phones and when traveling. Supervisors rely on end results and their judgment about people. Supervisory inputs about work time are transactional and subjective, and senior management has no factual data about exact workload in projects and business units. Hence, staff allocation is based exclusively on budgets and priorities, and hence not very optimal. Today's economy and competitive landscape demand exact continuing productivity improvements, which are not possible without automated effort visibility.

Today, companies attempt to measure work effort by requiring employees to fill-in timesheets. In an attempt to get breakup of the work effort, employees must enter time spent on different activities and tasks or deliverables. Such user input is very subjective. Since white collar employees do so many different things in office, both on their CS and away from them, they have no way of precisely tracking their total work time, let alone the breakup on different Activities and Purposes. Hence they usually fill in what is expected of them. The timesheets often limit the employee to specifying the statutory work hours (e.g. 8 or 8.5), rather than the actual hours put in. Hence, while lot of data is provided, it is inaccurate and misleading. Business decisions cannot be taken based on such flawed subjective data. Consequently, timesheets usually end up being an exercise for billing purposes, and not with a view to measure and improve work effort and productivity.

The prior art described below envisage automated solutions for limited capturing of work effort. This includes user interactions with the computer and some information regarding user's offline activity in one case. However, they are limited in coverage and suggest improvements in narrow areas, such as a business process or work profile, which need to be configured. They do not describe/offer a comprehensive automated capture of the user's time 24×7, both when working online on one or more different types of computing systems (PC, smartphone, tablet etc.) and offline on activities ranging from meetings, phone calls, lab work, travel, business visits and so on as obtained from different presence devices (smartphone, GPS, EPABX, swipe cards, biometric devices, cameras etc.). They do not teach how the activities and objectives of a user can be inferred based on the applications and artifacts being used, the source of offline time usage, and the role and position of the user in the organization. They do not adequately assure the employee of privacy by providing a local user interface on the employee's CS that enables the user to identify and block details of personal time. They do not describe restricting aspects of work time to fit the organization's culture and complying with the privacy laws of the countries that they operate in. Further, they do not teach how the effort of individual users can be aggregated as per the organization hierarchy and business attributes (such as roles, skills, locations, verticals, cost and profit centers), that are automatically retrieved from the organization's existing application data stores, and further analyzed to obtain objective per-employee metrics that allow performance comparison across any two or more organization sub-units, whether employee, team, project, business unit or the entire organization.

For example, Patent Application US 2006/0184410, Ramamurthy et al. discloses a system that can observe every user action on every user application on a CS. It automatically captures and stores how a user is interacting in real-time with business applications, including screen shots and actual data that is being provided to these applications, and how a user is using a keyboard and other input devices. It collects information from third-party servers for obtaining and storing an actual audio/video of what a user said or did typically within the context of the business process. The automated capture of user actions is designed to replace time-and-motion stopwatch based observations that cannot keep up with online work by users. This patent application discloses mapping what the user is doing against a process definition to identify a process. However, US20060184410 does not teach a comprehensive capture of the user's time in online and offline activities, and automatically mapping the same to ‘Activities’ and ‘Purposes’ that are generic and independent of a specific business process. For example, it does not disclose the automatic derivation of Purposes (projects or functions) assigned to the user based on his or her position in the organization hierarchy. Moreover, the system described by Ramamurthy does not disclose mapping of user's time to ‘Activity’ and ‘Purpose’ directly on the basis of online applications and artifacts being used, and the nature of offline activity, and also taking into account the user's position and role. Ramamurthy et al discloses how to obtain details of all user interactions only with a view to optimize either (1) a known business process or (2) or a to-be business process. It does not teach how to capture the user's effort at all times, whether in office and outside, online or offline, while working on a diversity of CS (PC, tablet, smartphone, shared PC with common login etc.) and offline as obtained from various Presence Devices such as electronic phone logs, swipe cards, smartphone with GPS, and so on. Ramamurthy et al does not provide methods and systems to protect employee privacy since the effort being captured is for a limited purpose of business process optimization, rather than all the effort in office and outside. Ramamurthy et al. does not disclose aggregation and rollup of user data as per the organization hierarchy and attributes, as collected automatically from the organization's existing application data stores.

Patent Application US 2010/0324964, Callanan et al. discloses tracking of a user's time spent on an assigned Work Profile to determine work hours and overtime on a project. Tracking is initiated after the user has logged into an instant messaging system. The work profile indicates the project, applications and work files assigned to the user. The system envisaged by Callanan stops tracking time if the application being used is not listed in work profile and the user does want it to be added to the profile. Callanan et al also teaches that offline work related contextual information is gathered from calendar and other applications. This patent application cites an ‘activity monitor’ whose function is only to indicate that the user is ‘active’ on the computer. Callanan does not teach how to automatically map the user's time to ‘Activities’ of interest to the organization (example, online ones like design, programming, testing, documentation, communication, and offline ones such as meetings, calls, lab work, travel, and visits), deduced automatically based on applications and files and links used, and the PDs whose identity indicates how the offline time is spent. Callanan requires explicit definition of a ‘Work Profile’ for each user, and does not automatically derive the Purposes (projects or functions) assigned to the user based on his or her position in the organization hierarchy. It does not teach how to capture the user's effort at all times, whether in office and outside, online or offline, while working on a diversity of CS (PC, tablet, smartphone, shared PC with common login etc.). Callanan et al only refers to offline time in the context of identifying a meeting from the calendaring application on the user's computer. However, it does not teach detecting the user's complete offline time on phone calls, lab and conference rooms, travel, and remote visits, from various Presence Devices such as electronic phone logs, swipe cards, smartphone with GPS, and so on. Further, the system described by Callanan does not disclose mapping of user's time to ‘Activity’ and ‘Purpose’ directly on the basis of online applications and artifacts being used, and the nature of offline activity, and also taking into account the user's position and role in the organization. Further, Callanan does not teach aggregation and rollup of user data as per the organization hierarchy and attributes, as collected automatically from existing data stores in the organization. Callanan et al also do not offer methods and systems for protecting employee privacy, including the capability to block some or all of the individual effort while still measuring and displaying aggregate effort.

Patent Application US20050183143, Anderholm describes automatic capture of time by monitoring system/user/device activity. The system envisaged by Anderholm tracks user's time on various applications on the user's computer, and events from other devices, processes the data, and aggregates the captured data for multiple users. The aggregated data is further compiled into a plurality of reports which could be accessed by a plurality of users based on their organizational hierarchy. This patent application discloses aggregating data in terms of events, users, computer types, department types and organizational hierarchy to name a few. However, Anderholm does not describe a 24×7 capture of user's time utilization, whether in office or at home or while traveling. In particular, Anderholm does not disclose capture of any offline time by interfacing to calendaring tools and presence devices. It does not automatically derive the Purposes (projects or functions) assigned to the user based on his or her position in the organization hierarchy. Further, application artifacts such as files, folders, web links are not captured, and hence there is no automated mapping of user time to ‘Activity’ and ‘Purpose’ that require inferences of user's intentions based on applications and files, folders and links being used, how and where the offline time is spent, and the user's organization attributes such as role and position. Anderholm discloses aggregation of users' time based on organization hierarchy, but does not teach how the hierarchy and other business attributes can be obtained automatically from existing organization application data stores. Further, Anderholm does not offer methods and systems for protecting employee privacy, including the capability to block some or all of the individual effort while still measuring and displaying aggregate effort.

Finally, there are some prior art tools that capture time spent on the CS on various online applications, and categorize them into productive and non-productive work. They are broadly referred to as employee monitoring tools. They are designed for an individual user to track the time utilization, or a small business where the management wants to track what each person is doing or needs to bill or pay for work on hourly basis. Like Anderholm, these tools do not track effort 24×7, both online on different kinds of CS, and offline for meetings, calls, lab work, travel, remote visits and so on. They do not automatically infer the Activities and Purposes for which the time was spent, based on applications and artifacts for online time, nature of offline time, and the user's role, position and other attributes relevant in the organization. Like Callanan, they are not able to provide organization level analytics and metrics that can drive comparison and optimization of effort in organization sub-units across the enterprise.

None of the existing solutions are able to account for work being done by the same user on multiple Purposes, or when they use a combination of computing systems such as a PC, smartphone, tablet, or when a shared CS is accessed by multiple users through a common login, or if the user works on a remote CS that belongs to a different organization. While a few tools track meetings scheduled through a calendar, they do not track offline time utilization on calls, lab work, travel, remote visits, by sourcing them from various Presence Devices (PDs) such as IP phones, EPABX, mobile phones, smartphones, GPS, swipe cards, biometric devices, and cameras. They do not specify automated collection of organization hierarchy and business attributes, without which the intelligent mapping of user time to Activities and Purposes is not possible. They do not disclose the computation of any per-person Work Patterns and productivity metrics that allow for objective comparison between one or more organization sub-units of any size, from one employee to the entire organization. Deriving a per-person metric requires being able to detect and handle complexities such as multiple-level hierarchy, matrix organization structures, employees working in more than one project and across business units, multiple managers, shift timings and variable work weeks. Hence, they do not provide online automated analysis of effort data across various business dimensions such as geography, verticals, employee skill sets, and salaries and so on.

Apart from the ability to stop tracking of user's time either manually or outside of the business process being covered, none of the existing tools describe methods to protect individual privacy as per the requirements of each organization and to comply with privacy policies in different countries. Ideally, a user interface should be available on the employee's CS that enables the user to verify, and if required mark the time spent on personal activities, which are then no longer available to the organization. Visibility into only work related individual data may be restricted to only some senior managers. Some organizations may opt for an anonymous mode, wherein only team level work effort is visible. It may be necessary to track work effort only up to a certain level in the organization. Finally, some organizations may wish to restrict visibility into work effort to only certain high level aspects (for example, excluding details of applications and artifacts), and only as average time on daily or weekly or monthly basis.

Therefore there is felt a need for a completely automated system that can precisely capture all the work effort which in today's environment may be at any time during the day (24 hours) and week (7 days), and map it to Activities and Purposes that are automatically inferred. The captured work effort from each employee must be aggregated and analyzed as per the organization's hierarchy and business attributes that are automatically collected from existing organization application data stores. The system must deliver actionable and objective metrics that can help optimize enterprise effort in every aspect of the business. It must also provide required protection for individual privacy, and restrict visibility of work effort as per the requirements of the organization and privacy laws of the countries it operates in. Finally, senior management should have access to a global platform where they can compare their own organization's productivity and work effort in relation to with other peer organizations.

### OBJECTS

It is an object of the present disclosure is to provide an intelligent and highly automated system to measure, record, analyze, report and improve the work effort put into various Activities and Purposes for an organization by individuals, teams and organization sub-units assessed as per the organization hierarchy and related business attributes.

A related object of the present disclosure is to provide a system that automatically determines each employee's effort throughout the day (24 hours) and week (7 days), whether performed online on one or more computing systems (CS), and offline such as for meetings, lab work, calls, outside travel, and remote visits. This effort is mapped to Activities and Purposes relevant for the organization and which are derived automatically for each user based on his or her organization role.

A related object of the present disclosure is to provide a system that automatically tracks the exact time spent by the employee on one or more personal CS, any CS shared with other users through a common login, and remote servers (even if the servers do not belong to the organization), by determining the user's time on the currently active application and associated artifacts such as files, folders, websites and other artifacts related to the applications.

Another related object of the present disclosure is to provide a system that automatically detects whenever the user is away from any CS, and mark this time as offline time on the CS.

One more object of the present disclosure is to provide a system that merges the user's online and offline time information sourced separately from one or more CS, and PDs and PD servers, for a consolidated view of the user's time utilization on applications and related artifacts and offline on meetings, calls, lab work, travel, remote visits and so on.

It is a further object of the present disclosure to provide a system that intelligently deduces and maps each online and offline time slot to the most appropriate Activity and Purpose from a hierarchy of possible Activities and Purposes assigned to the employee from a master list for the organization, based on applications and artifacts in case of online time slots, and for offline slots from information obtained from calendaring systems and various PDs (Presence Devices) and PD servers that indicate if the user was busy in meetings, calls, lab work, travel, remote visits, and so on.

Yet another object of the present disclosure is to provide a system that infers the Work Patterns of the user such as leaves taken, work done on holidays, desk job done mostly online on one or more CS, supervisory work involving online and offline work, travel oriented work mostly offline and away from office, shift timings, variable work week, uninterrupted work focus on important activities, number of distractions per work day, work units completed and so on.

Another object of the present disclosure is to make available a system that provides the user with a local user interface on the employee's CS, which is intended for private display of user's time utilization, both personal and work related.

Yet another object of the present disclosure is to make available a system that provides for user side gamification and encourages improved work habits by setting challenges related to work focus and minimizing distractions, awarding performance points, badges for consistent performance, and progressive performance levels.

One more object of the present disclosure is to make available a system that provides for exact effort and time productivity measurement at organization level without any manual definition or configuration of employee groups or attributes.

The present disclosure envisages a system adapted to configure a master list of Activities and Purposes, derived from the organization hierarchy (which represents projects and functions) and business attributes (which determine the relevant Activities for a particular type of organization and its sub-units), and the master list may be multi-level and adapted for each organization sub-unit and user.

The present disclosure also envisages a system adapted to configure default rules for mapping online and offline time slots to Activities and Purposes, and adapt the mapping rules for organization sub-units based on their business attributes, and further adapt them for each user based on his or her position in the sub-unit hierarchy and the user's role therein.

A further object of the present disclosure is to provide a Data Exchange framework for shared database and programmatic interface with third party applications for project management, performance tracking, HR systems, quality, project accounting, resource management and the like.

A related object of the present disclosure is to provide a system that collects the daily effort of each individual employee, consolidates and rolls it up as per the organization hierarchy defined at the Server, and provides analytics, reports, goal compliance, alerts and rewards notifications responsive to said exact effort data across Purposes, Activities, applications, artifacts, organization hierarchy and attributes.

Yet another object of the present disclosure is to provide a system that derives a per-employee Daily Average of Work Pattern, as part of the built-in analytics, specifically to allow for meaningful comparison between two or more organization sub-units, irrespective of the nature of business and role.

A related object of the present disclosure is to provide a system that computes the per-employee Daily Average of Work Pattern for a requested organization sub-unit for the specified time range.

One more object of the present disclosure is to provide a system that creates an n-dimensional effort data cube and includes an analytics engine to provide for generation of custom reports by defining the parameters to be viewed and compared against, filters for selecting a subset, in which the parameters comprise any and every data item sourced, including online and offline time, applications, Activities, Purposes, artifacts, organization sub-units, organization attributes, along with ability for statistical analysis based on totals, averages, maximum and minimum values, standard deviations and others.

A further object of the present disclosure is to provide a system that enables higher productivity, increased output, and improved capacity utilization, by setting goals for greater yet reasonable effort, and more focused time on key Activities and Purposes, by highlighting the gap between current and desired performance, as well as the performance of the Top 20% at the level of organization sub-units and individual employees.

It is another object of the present disclosure is to provide a system that determines under and over utilization of effort capacity at any level of the organization hierarchy or along business attributes, and thereby optimizes staffing for maximum organization efficiency and employee work-life balance.

One more object of the present disclosure is to provide a system that deduces recent positive and negative deviations in Work Patterns, and generates an exception report with suggested actions that can be taken to drive improvement.

One more object of the present disclosure is to provide a system that protects the user privacy by not allowing any visibility into user's personal time details, optionally providing the user with a private time selector to disable employee's time tracking for specified duration, optionally blocking access to work related details such as applications and artifacts, and optionally reducing the resolution of user's work data to daily, weekly, or monthly averages instead of real-time information to make it seem less intrusive.

A further object of the present disclosure is to provide administrative capabilities to the organization to limit individual level work data visibility only to a few selected staff members, and disabling individual work data view for senior staff (above a certain designation).

One more object of the present disclosure is to provide a system that complies with privacy laws of the organization or specific countries where they operate in by providing an ‘anonymous’ mode in which individual data visibility is completely blocked, and only team level trends and reports are possible.

Yet another object of the present disclosure is to provide a system that includes a ‘self-improvement’ mode in which no user data is uploaded to the Server and productivity improvements are achieved at employee level through personal goal setting and self-awareness based on the Work patterns provided on the local CS.

One other object of the present disclosure is to make available a system that provides each user with a web based user interface, in addition to the local user interface, to enable access over any internet browser to long term work related trends, reports, alerts, goals, and administrative functions on the Server, for the individual's own data as well as for the teams and organization units reporting to the user.

A further object of the present disclosure is to provide a social platform that showcases the top performers and award winners at individual and organization sub-unit level, motivates gains through a recognition-and-rewards system based on goals achieved, performance points, badges, levels, and allows users to socialize personal and team achievements.

An object of the present disclosure is to create a Global Work Pattern Knowledge Platform in which organizations across various industries, verticals, countries, and scale, can participate by contributing their high level work pattern trends and analytics with assured anonymity, and in return get feedback on how they rate relative to peer organizations selected based on the criteria, of interest.

### SUMMARY

The present disclosure captures all employee work, whenever and wherever it is performed, including online using multiple devices such as computers, tablets and smartphones, and offline through business calls, meetings, remote visits to meet customers and suppliers. Further, the present disclosure automatically discovers the organization structure and business attributes from the existing organization databases, and computes and analyzes the collective work effort across relevant business dimensions. The analysis is further extended to a global view across participating organizations.

The present disclosure envisages a computer implemented system for measuring, aggregating and analyze the exact effort and time productivity of at least one user. The system, in accordance with the present disclosure comprises:
at least one Computing System (CS) Agent associated with a user accessing at least one Server, said CS Agent adapted to automatically measure and generate consolidated and exact online and offline effort data throughout the day (24 hours) and week (7 days), said CS Agent having access to:
   a master list for each user containing his or her Purposes and Activities, role and business attributes, said master list automatically preconfigured at the organization level Server based on the user's role and other work related attributes; and
   a rule and pattern mapping engine containing the organization settings and current user specific mapping rules for mapping applications and offline and offline slots;
a user identifier adapted to identify a user by his or her unique login ID available with the Computing System, said user identifier further configured to prompt the user for the ID in case a neutral login ID is being used by more than one user;
a time tracker having access to said CS agent and adapted to track the user's online time on a currently active user application and associated artifact (file, folder, website) from a multiplicity of open applications on the Computing System, and record the name of the active application and artifact names and duration of usage, said time tracker further adapted to mark the user's offline time slots by determining each period of inactivity time during which no movement of physical input devices such as keyboard, keypad, touchpad, and mouse of the Computing System is detected for more than a predetermined period of time;
a comparator adapted to compare scheduled engagements, meetings, calls, lab work, travel time and remote visits of said user as obtained from the user's calendar on the Computing System and from local Presence Devices (PDs) such as smartphone with GPS that are connectable to or part of the Computing System, with the duration of said offline time slots for determining the user's offline time utilization;
a logger adapted to maintain a consolidated and sequential log of user's online and offline time slots,
a time analyzer adapted to map said logs of said slots to an appropriate Activity (such as planning, design, programming, testing, documentation, communication, meetings, calls, lab work, travel, and visits) and Purpose (assigned projects, functions and tasks) based on the mapping rules and further adapted to generate and upload an effort map of the user on said Server;
a merger, resident in the Server, said merger adapted to obtain, from all the user's CS Agents and from the Server side PD, the user's online effort map and offline effort map, said merger further adapted to merge said offline and online effort maps and generate a final user effort map and further adapted to download the final effort map back onto each of the CS Agents of the user;
an inference engine adapted to periodically receive final user effort maps and further adapted to determine Work Patterns of the user such as leaves taken, work done on holidays, desk or supervisory or travel oriented job, shift timings, variable work week, work focus, distractions, and completed work units;
a local user interface adapted to receive inputs from said inference engine and display privately to the user the Work Pattern trends for a predetermined period, and further adapted to review and edit Activity-Purpose mappings; and
a user private time selector adapted to disable a user's time tracker for specified time slots, which is marked as an Unaccounted and Private time slot.

In accordance with the present disclosure, the server comprises:
a CS Agent interface configured to collect effort data from every Computing System for each user, wherein the effort data is in the form of an CS effort map, said effort map configured to list in a chronological order, the online and offline time for each user;
a PD interface configured to determine the offline effort map for each user by obtaining information about user's time on business calls, meetings, visits to labs and other intra-office locations, business travels, and time spent at customer/vendor locations, by interfacing with all remote presence devices and PD servers;
a server effort map unit configured to merge said CS effort map and said offline effort map for every user, and generate a chronologically accurate and complete user effort map, said complete effort map uploaded back to every user's Computing System;
an organization sync agent configured to automatically collect and maintain the list of current valid users and organization hierarchy that maps each user to one or more organization units, said organization sync unit further configured to collect and maintain the business attributes (role, skills, salary, position, location) qualifying each user, and organization sub-unit (domain, vertical, cost and profit center, priority) from the organization's existing application data stores;
an organization settings and rules engine adapted to configure a master list of Activities and Purposes, derived from the organization hierarchy (which represents projects and functions) and business attributes (which determine the relevant Activities for a particular type of organization and its sub-units), and said master list may be multi-level and adapted for each organization sub-unit and user, said organization settings and rules engine further adapted to configure default rules for mapping online and offline time slots to Activities and Purposes, said rules engine further configured to adapt the mapping rules for organization sub-units based on their business attributes and further adapted for each user based on his or her position in the sub-unit hierarchy and the user's role therein;
an organization effort aggregation and analytics engine configured to consolidate and roll up individual online and offline effort data as per the organizational hierarchy, said engine further configured to compute a per-employee daily average work pattern for each sub-unit, said engine still further configured to generate an n-dimensional effort data cube mapping individual and collective efforts of respective users as per the organizational hierarchy and business attributes;
a recognition and rewards module configured to assign performance points to users based on the respective individual efforts of the users; and
a web based user interface configured to facilitate views at each level of the organization hierarchy across multiple dimensions such as purpose, activity, applications, projects, functions, artifacts and business attributes such as employee levels, roles, skills, locations, verticals, technologies, cost centers, said user interface further configured to selectively filter and drill down to generate discrete effort data.

In accordance with the present disclosure, the web based user interface is configured to:
communicate with an internet browser and display through said internet browser the organizational trends, reports, alerts, goals and administrative functions depending upon the user's position and role in the organizational hierarchy and assigned access rights; and
provide access to the organization effort aggregation and analytics engine for generation of user defined custom reports from said n-dimensional effort data cube.

In accordance with the present disclosure, the organization effort aggregation and analytics engine is further configured to deduce the best working pattern, top performers at individual and organization sub-unit level, said organization effort aggregation and analytics engine further configured to determine unusual work patterns and the recent positive and negative deviations in work patterns for an organization sub-unit, said organization effort aggregation and analytics engine still further configured to generate a report including specific actions that can be undertaken to improve the efforts of the users.

In accordance with the present disclosure, the Computing System includes a user interface local to said Computing System configured to provide the respective users with private access to the corresponding online and offline effort data.

In accordance with the present disclosure, the Computing System includes a blocker configured to:
mark all effort that is not identified as being on work related activities by the users' mapping rules as personal time;
enable each user to explicitly block any time that was marked as work by the user's mapping rules but which the user wishes to mark as personal;
block all third party access to users' personal time details;
block third party access to some of the users' work related information including applications and artifacts (files, folders and websites);
reduce the granularity of the users' work related information to a daily, weekly, or monthly average of the work patterns;
control third party access to individual level data by restricting the access to said individual level data based on the organizational hierarchy and as per assigned access rights; and
block individual data visibility for certain users based on their role or seniority in the organization.

In accordance with the present disclosure, the blocker can be further configured to actuate an ‘anonymous mode’ wherein the visibility of individual effort data is completely blocked for the entire organization or for sub-units in certain geographies, and trends and reports are available only up to team level provided the team has a certain minimum number of employees.

In accordance with the present disclosure, the blocker can be further configured to actuate a ‘self-improvement mode’ wherein:
no effort data is uploaded by default to the server;
productivity improvements are achieved through employee self-awareness by tracking user's own work patterns as provided on the local Computing System and by comparing against the goals set by the managers and the organization;
work patterns are uploaded anonymously to the server, in return for being able to view the comparative trends across the users who shared their respective effort data and rate one's own relative performance; and
user's profile such as role, seniority, location and skills are defined and comparisons are made with peers having a similar profile.

In accordance with one embodiment of the present disclosure, the system further includes:
a global pattern knowledge platform configured to enable the participating organizations to share their high-level work pattern analytics and trends based on employee and sub-organization categories;
a profile definition module configured to enable the participating organizations to define profiles corresponding to at least their respective sizes, industry and vertical;
a report generation module configured to prepare reports rating the organization's performance and standing relative to peer organizations in accordance with the selected profile criteria.

In accordance with the present disclosure, the CS Agent can be selected from the group consisting of a computer desktop, laptop, electronic notebook, personal digital assistant, tablet, and smartphone.

In accordance with the present disclosure, the time tracker is further configured to ignore any simulated input device or spurious movement through the robotic control of the physical devices.

### BRIEF DESCRIPTION OF THE ACCOMPANYING DRAWINGS

Other aspects of the disclosure will become apparent by consideration of the accompanying drawings and their descriptions stated below, which is merely illustrative of a preferred embodiment of the disclosure and does not limit in any way the nature and scope of the disclosure.

FIGS. 1 and 1A are flowcharts of steps for the exact effort and time productivity measurement process from individual to every level of the organization, and finally to high level comparative data across organizations at a global work pattern knowledge platform;

FIG. 2 is a schematic of the system to measure, aggregate, analyze and improve the exact effort and time productivity of employees at an organization in accordance with the present disclosure, comprising of at least one CS Agent cooperating with at least one Server;

FIG. 3 is a schematic of the CS Agent to automatically measure the employee's online and offline time utilization and map to Activity and Purpose, along with a local User Interface to review and improve user's own effort and Work Patterns;

FIG. 4 is a schematic of the Server to collect user time utilization data from all available CS Agents, automatically collect organization hierarchy and business attributes, and aggregate and analyze the exact effort and time productivity of employees, teams and organization sub-units, to deliver actionable metrics for productivity improvements;

FIG. 5 is an illustration of a Global Knowledge Platform configured for collecting Work Pattern trends across industries, verticals, countries, roles and timelines. This is based on Work Pattern data collected from contributing organizations in return for being able to perform relative comparisons and ranking with peer organizations; and

FIG. 6 is an illustration of how automatic configuration of the master list of Activities and Purposes for an organization, and the user-wise list of valid Activities and Purposes and mapping rules, is achieved based on the organization hierarchy and business attributes obtained from the organization's existing application data stores.

### DETAILED DESCRIPTION

The system and method for automated measurement, recording, analyzing and improving work effort of employees, teams, and organization sub-units, will now be described with reference to the accompanying drawings which do not limit the scope and ambit of the present disclosure. The description provided is purely by way of example and illustration.

In view of the drawbacks associated with the prior art systems, there was felt a need for a completely automated system that can precisely capture all the work effort which in today's environment may be at any time during the day (24 hours) and week (7 days), in office and outside the office, by using a multiplicity of different computing systems such as office computer, laptop, smartphone, and while offline on meetings, lab work, business calls, outside travel and remote meetings. Work and personal time has to be differentiated, and work time must be further mapped to business related Activities and Purposes that are automatically inferred. There was also felt a need for the captured work effort from each employee, to be aggregated and analyzed as per the organization's hierarchy and business attributes that should be automatically collected from the organization's existing application data stores. There was felt a need for a system that could deliver actionable and objective metrics that can help optimize enterprise effort in every aspect of the business. The system should also provide required protection for individual privacy, and restrict visibility of work effort as per the requirements of the organization and privacy laws of the countries it operates in. The senior management of an organization should have access to a global platform where they can compare their own organization's productivity and work effort in relation to with other peer organizations.

A computer implemented system designed to answer the aforementioned needs should have the following capabilities:
Collector to measure and improve the exact work effort at individual level throughout the day by:
   tracking the online time spent by employees on one or more computing system (CS) including desktop, laptop, any CS that is shared by multiple users through a common login, and remote servers;
   tracking the offline time spent away from the CS in work related meetings, phone calls, lab and other work areas in the office, travel and meetings at remote locations;
   differentiating work and non-work related time, with the non-work time details not made available to the organization;
   mapping the individual's work time intelligently to Activities and Purposes based on the online applications and artifacts used, the source of the offline time (type of PD), and the individual's role and the organization sub-unit that the employee belongs to;
   automating the entire capture of work time, both online and offline, and mapping to Activities and Purposes, and eliminating all user input or limiting it to the barest minimum;
   inferring the Work Patterns of the user such as the leaves taken, work done on holidays, desk job done mostly online on one or more CS, supervisory work involving online and offline work, travel oriented work mostly offline and away from office, shift timings, variable work week, uninterrupted work focus on important activities, number of breaks taken, work units completed and so on;
   providing the employee with a local User Interface to privately view the time utilization on personal and work activities, and ensure adequate work effort by benchmarking against goals (set by the individual, manager, or at organization level);
   computing productivity parameters such as sustained focus on core activities and limiting distractions (e.g. breaks, calls, emails) and work units completed to enable self-improvement and optimize work-life balance; and
   promoting good work habits through a recognition-and-rewards system based on performance points earned for goals achieved and consistency, progressive performance levels, and badges.
Collector and Analyzer to measure exact enterprise effort, provide accurate comparative benchmarks, and optimize business efficiency, as follows:
   collect the time utilization data from each CS for all the employees, with breakup across the Activities and Purposes of interest, at a central Server;
   automatically collect the organization hierarchy (grouping of individual employees into teams, projects, divisions in one or more hierarchies based, for example, on functions, services lines, and locations) from the organization's existing application data stores;
   automatically source the attributes that qualify employees' role (such as level, location, skills, salary), projects and functions and organization sub-units (for example, revenue and R&D and cost centers, verticals, technologies) from various existing application data stores;
   configure a master list of Activities and Purposes, derived from the organization hierarchy (which represents projects and functions) and business attributes (which determine the relevant Activities for a particular type of organization and its sub-units), and said master list may be multi-level and adapted for each organization sub-unit and user;
   configure default rules for mapping online and offline time slots to Activities and Purposes, said rules adapted for organization sub-units based on their business attributes and further adapted for each user based on his or her position in the sub-unit hierarchy and the user's role therein;
   aggregate and map individual effort as per the organization hierarchies and attributes;
   derive the per-employee Daily Average Work Pattern for any organization sub-unit, specifically to allow for meaningful comparison between two or more organization sub-units (ranging from the entire company, business units to individuals), across any time range, and irrespective of the nature of business and role;
   compute the said per-employee Daily Average Work Pattern for any specified sub-unit and duration of interest, for which it becomes necessary to infer and account for the various complexities such as employees working on multiple CS, in more than one project, employees with different roles, shift timings, variable work weeks, holidays and vacations, work done while on holidays and vacation days, geographically distributed teams with different work weeks and holidays, variable nature of work in different organization sub-units, complex organization hierarchies including matrix structures etc.
   create an n-dimensional effort data cube and analytics engine to allow generation of custom reports by defining the parameters to be viewed and compared against, filters for selecting a subset, in which the parameters comprise any and every data item sourced, including online and offline time, applications, Activities, Purposes, artifacts, organization sub-units, organization attributes, along with ability for statistical analysis based on totals, averages, maximum and minimum values, standard deviations etc.
   provide analytics, reports, goal compliance, alerts and rewards notifications responsive to said exact effort data across Purposes, Activities, applications, artifacts, organization attributes, supported by the further ability to selectively filter and drill down to generate and review discrete effort data at level of sub-unit and individual employees to meet the corporate commitments;
   allow access to analyzed data as per the organization hierarchy and permitted access rights to various roles;
   provide a platform to showcase the best Work Patterns at the level of any desired sub-unit, notify top performers in terms of performance points and badges earned, and publish awards;
   deduce recent positive and negative deviations in Work Patterns for any organization sub-unit, and generate a report on specific actions that can be taken to drive improvement; and
   create an open database and data exchange capability to interconnect with other organization applications related to project management, performance tracking, HR systems for vacations and appraisals, project accounting, budgeting and so on.
Individual privacy protection by providing administrative controls that allow each organization to strike the desired balance between work effort visibility and respect for privacy, for meeting organization requirements and for complying with privacy laws, through the following three options:
   User Private Time
      guarantee that details of time spent on personal work outside of office is not available to the organization;
      provide a local user interface on each CS for the employee so that details of personal and work time are available for private viewing, and only selected elements of the work data become available to the organization for consolidation on a central server;
      block details of time on personal work while in office as well, except when explicitly requested by the organization in which case the employee is made aware of it;
      optionally, provide users with a private time selector during which employee's time tracking is disabled for specified duration, and the entire time is marked as Unaccounted and Private;
      individual users will always have full visibility to their work and personal time data on their local CS
   Details of Work Time visible to the organization
      block work time on any of the following: applications, artifacts (files, folders, websites);
      select frequency: default is real-time, but can be changed to daily, weekly or monthly average of Work Patterns to make it less intrusive;
      option for ‘self-improvement mode’ in which user data is never uploaded to the Server, and employees are expected to self-improve using their data on the local CS
   Limiting Visibility of employee level work data
      limit visibility of individual work data as per the reporting hierarchy, and as per the access rights for various roles;
      option to allow individual level data visibility only to select managers for their direct reports;
      option for blocking individual data visibility for certain employees, for example those at higher position in the organization;
      option for ‘anonymous’ mode wherein visibility of individual data and also small teams fewer than ten employees (or as required) is not available to anyone in the organization.
A Global Work Pattern Knowledge Platform in which organizations across various industries, verticals, countries, and scale, can share their high level work pattern trends and analytics with assured anonymity, and in return compare their rating with peer organizations.

The system envisaged by the present disclosure captures all the work effort which in today's environment which may be at any time during the day (24 hours) and week (7 days). These include office workers spending most of their work time on computers, and marketing and sales staff making extensive business calls and travelling to customer locations. Systems and methods have been described to track the daily time spent by employees, irrespective of whether the time is spent on one or more computing devices, or away from any computing system while in meetings, discussions, calls, lab work, outside travel, and remote visits. This is mapped to activities and objectives that are automatically inferred based on the applications and artifacts being used, the source of offline time usage, and the employee's position in the organization and role therein. The captured individual work effort is mapped to the organization's hierarchy and business attributes. This organization data is automatically collected from existing organization application data stores, and does not require any manual definition or configuration. As a result, it becomes possible to identify the work patterns and trends within each sub-unit and operational dimension of the business, and hence providing a powerful platform for enterprise wide effort and capacity optimization. The system envisaged by the present disclosure delivers actionable and objective metrics that can drive accountability across management layers for the work effort of the teams they are responsible for, and ensure productivity improvements and optimal staffing to accomplish the desired results in every aspect of the business.

The present disclosure discloses a variety of methods and systems to meet the needs of employee privacy, organization culture, and the different privacy laws of countries where the organization may operate. This includes not allowing access to individual personal time details, a local user interface that enables the user to confirm this, and providing individual work data visibility to the organization only to the extent appropriate, including the option of voluntary sharing of work trends by employees.

Finally, the present disclosure envisages a Global Work Pattern Knowledge Platform, wherein organizations across various industries, verticals, countries, and size, can participate by contributing their high level work pattern trends and analytics, and in return get feedback on how they rate relative to peer organizations, with anonymity assured for all participants.

A key aspect of the present disclosure is an intelligent system that automatically determines each employee's effort throughout the day (24 hours) and week (7 days), when performed online on one or more computing systems, and offline on business meetings, lab work, business calls, outside travel, and remote meetings. The employee's effort is mapped to Activities and Purposes that are also automatically inferred based on the applications and artifacts being used online, the source of offline time usage, and the employee's role and position in the organization.

A second aspect of the present disclosure includes a system to aggregate each employee's effort as per the organization's hierarchy and business attributes that are automatically collected from existing organization application data stores, and analyze them to deliver actionable and objective metrics, such as a per-employee Daily Average Work Patterns, that can drive accountability across management layers for the work effort of the teams they are responsible for, and ensure productivity improvements and optimal staffing to accomplish the desired results in every aspect of the business.

According to a third aspect of the present disclosure, methods are described that allow the organization to set administrative policies for protection of individual privacy consistent with its own requirements and for complying with privacy laws in the countries that they operate in. The policies regulate collection of only work effort excluding details of personal time, restricting visibility of individual work data, and limiting the frequency and details of work effort that is collected.

A fourth and final aspect of the disclosure describes a Global Work Pattern Knowledge Platform in which participating organizations share their collective Work Pattern analytics and trends in anonymous mode, and in turn they can perform relative comparisons and ranking with peer organizations across industries, verticals, countries, roles and timelines.

Aspects of the present disclosure will become apparent by consideration of the accompanying drawings and their descriptions stated below, which is merely illustrative of a preferred embodiment of the disclosure and does not limit in any way the nature and scope of the disclosure.

The present disclosure teaches a system for measurement, aggregation, analytics and improvement of exact organization effort and time productivity. In accordance with one aspect of the present disclosure, the system is based on a client-server architecture where each one of the employee's CS is loaded with a client application which automatically tracks time utilization, intelligently maps it to Activities and Purposes based on default rules that may be optionally remapped by the employee, and communicates the effort data (Time-Activity-Purpose) to a central Server for further storage, aggregation and analysis. The Server can be hosted within the organization on a single physical server machine or on multiple machines to accordingly distribute the workload. Alternatively, the Server can be provisioned for more than one organization as part of a Software as a Service (SaaS) solution by hosting it within a cloud computing infrastructure. On the same or a different SaaS server, a Global Work Pattern Knowledge Platform is provided on which participating organizations share their collective Work Pattern analytics and trends in anonymous mode, and in turn they can perform relative comparisons and ranking with peer organizations across industries, verticals, countries, roles and timelines.

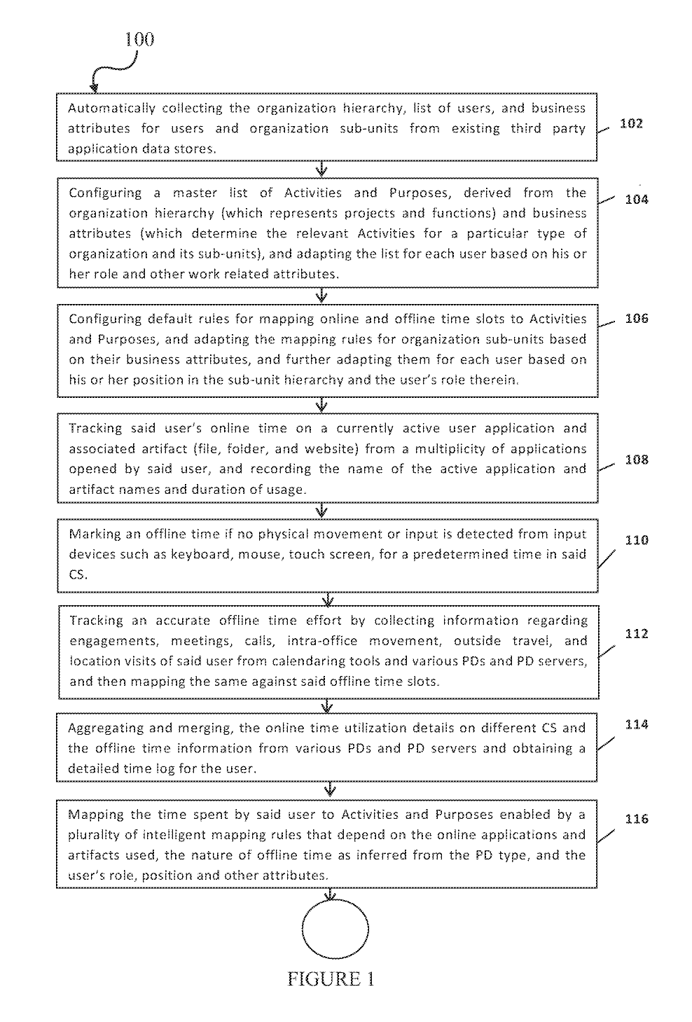

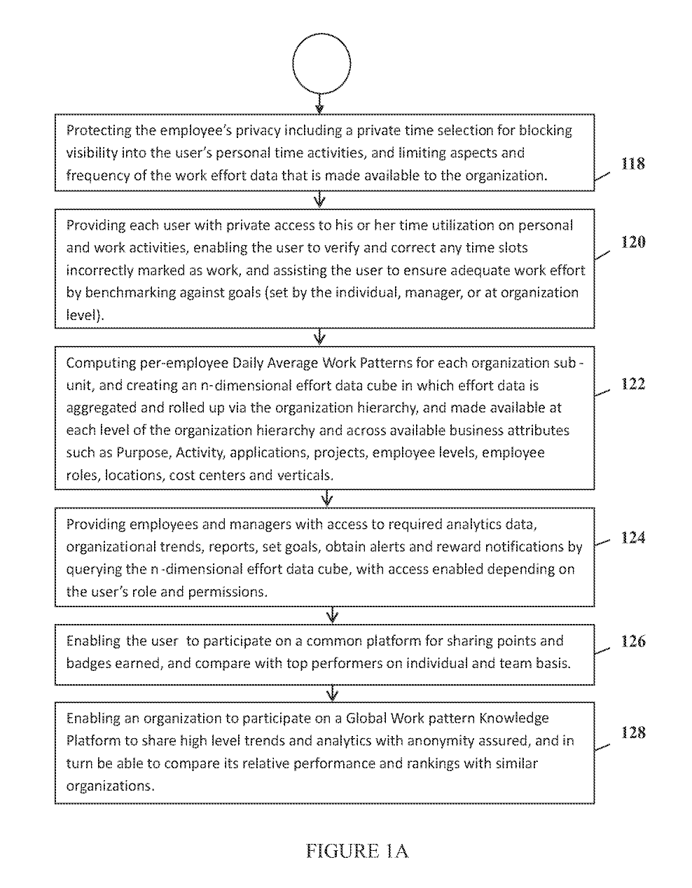

Referring to the accompanying drawings, FIGS. 1 and 1A are flow charts of a method 100 for exact effort and time productivity measurement, as per the following steps:
A first step 102 includes automatically collecting the organization hierarchy, list of users, and business attributes for users and organization sub-units from existing third party application data stores.
A second step 104 includes configuring a master list of Activities and Purposes, derived from the organization hierarchy (which represents projects and functions) and business attributes (which determine the relevant Activities for a particular type of organization and its sub-units), and adapting the list for each user based on his or her position in the organization hierarchy and role therein.
A third step 106 includes configuring default rules for mapping online and offline time slots to Activities and Purposes, and adapting the mapping rules for organization sub-units based on their business attributes, and further adapting them for each user based on his or her position in the sub-unit hierarchy and the user's role therein.
A fourth step 108 includes tracking said user's online time on a currently active user application and associated artifact (file, folder, and website) from a multiplicity of applications opened by said user, and recording the name of the active application and artifact names and duration of usage.
A fifth step 110 includes marking an offline time if no physical movement or input is detected from input devices such as keyboard, mouse, touch screen, for a predetermined time in said CS.
A sixth step 112 includes tracking an accurate offline time effort by collecting information regarding engagements, meetings, calls, intra-office movement, outside travel, and location visits of said user from calendaring tools and various PDs and PD servers, and then mapping the same against said offline time slots.
A seventh step 114 includes aggregating and merging, the online time utilization details on different CS and the offline time information from various PDs and PD servers and obtaining a detailed time log for the user.
An eight step 116 includes mapping time spent by said user to Activities and Purposes enabled by a plurality of intelligent mapping rules that depend on the online applications and artifacts used, the nature of offline time as inferred from the PD type, and the user's role, position and other attributes.
A ninth step 118 includes protecting the employee's privacy including a private time selection for blocking visibility into the user's personal time activities, and limiting aspects and frequency of the work effort data that is made available to the organization.
A tenth step 120 includes providing each user with private access to his or her time utilization on personal and work activities, enabling the user to verify and correct any time slots incorrectly marked as work, and assist the user to ensure adequate work effort by benchmarking against goals (set by the individual, manager, or at organization level).
A eleventh step 122 includes computing per-employee Daily Average Work Patterns for each organization sub-unit, and creating an n-dimensional effort data cube in which effort data is aggregated and rolled up via the organization hierarchy, and made available at each level of the organization hierarchy and across available business attributes such as Purpose, Activity, applications, projects, employee levels, employee roles, locations, cost centers, verticals, and so on.
A twelfth step 124 includes providing employees and managers with access to required analytics data, organizational trends, reports, set goals, obtain alerts and reward notifications by querying the n-dimensional effort data cube, with access enabled depending on the user's role and permissions.
A thirteenth step 126 includes enabling the user to participate on a common platform for sharing points and badges earned, and compare with top performers on individual and team basis.
A fourteenth step 128 includes enabling the organization to participate on a Global Work pattern Knowledge Platform to share high level trends and analytics with anonymity assured, and in turn be able to compare its relative performance and rankings with similar organizations.

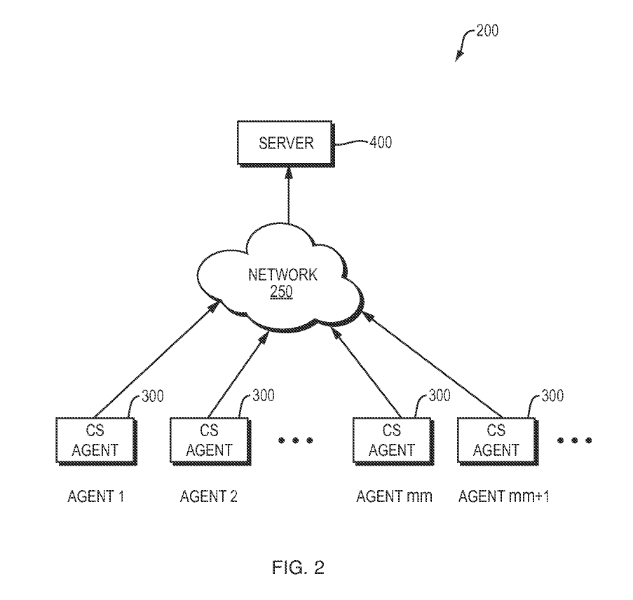

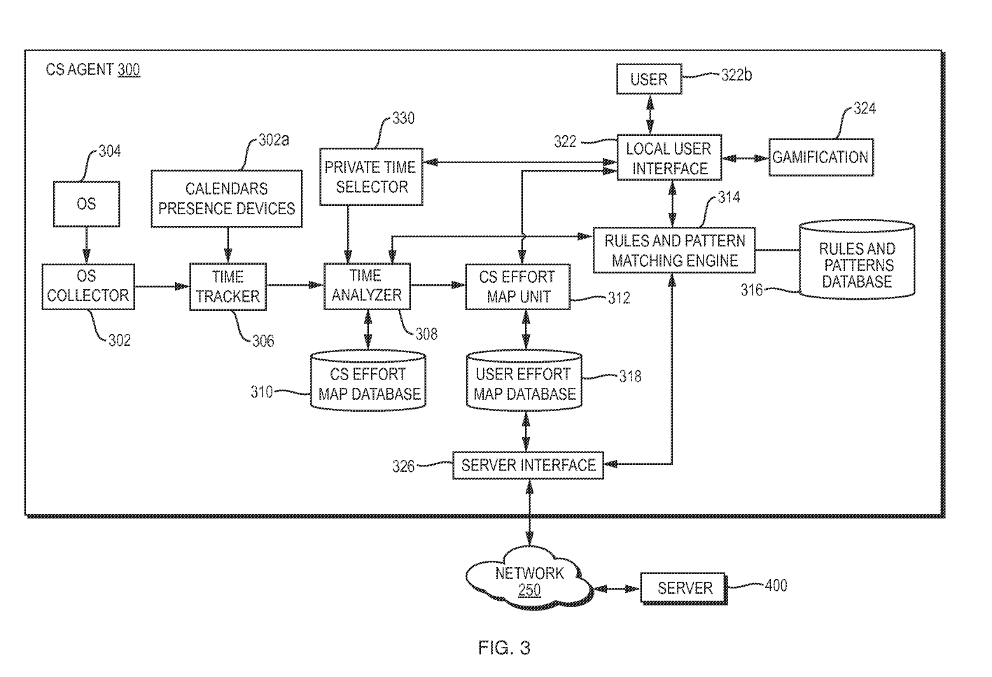

A system for implementing the steps noted in FIGS. 1 and 1A is now described. Referring to the accompanying drawings, FIG. 2 shows a schematic 200 of the system to automatically measure, aggregate, analyze and improve an organization's collective work effort and individual time productivity. The system includes at least one CS Agent per employee, cooperating with at least one Server communicating over the network 250. The CS Agent is adapted to generate exact effort data for a user and said Server providing the exact effort data and analytics for an organization. FIG. 3 is a schematic of the CS Agent 300 and its components, as described further below:

Operating System (OS) Collector 302: The OS Collector 302 runs in the background of the user's CS and collects events related to the user's interaction with the CS and status of current active application window and artifacts related to the application, by interfacing with the CS's Operating System 304. It also picks up data from local calendaring applications and local PDs 302A interfacing with the CS, regarding time spent away from the CS on meetings, calls, travel and the like.

Time Tracker 306: The Time Tracker 306 receives the collected data from the OS Collector 302 and aggregates the data chronologically into time slots pertaining to online time on applications and artifacts on the Computing System of the user (322B) CS and offline time on scheduled meetings, calls and travel as obtained from local calendaring applications and PDs.
Time Analyzer 308: The Time Analyzer 308 takes the output of the Time Tracker 306 and maps the time slots to Activity and Purpose (along with any user annotations) based on inputs from the Rules and Pattern Matching Engine 314. The resulting output is stored in the CS Effort Map database 310. For example:
time spent on email applications such as Outlook and Lotus Notes (both desktop) and gmail (web application), and chat programs, can be marked to the ‘Communication’ Activity;
In an IT organization, time spent on the Visual Studio engineering application will be marked to ‘Programming’ Activity for an employee who is a programmer, and ‘Test/QA’ Activity for a tester;
time on calls made to known customer numbers, as obtained from PDs such as mobiles and EPABX logs, can be marked to an Activity called ‘Calls’ and Purpose being the user's current project or function; and
time spent on travel and remote visits that are identified as a customer location using Google Maps, can be marked as ‘Sales Visits’ for personnel in the sales team. CS Effort Map Unit 312: The CS Effort Map Unit 312 uploads the CS Effort Map to the Server 400, where the Server Effort Map Unit 408 consolidates the Effort Maps that are obtained from all the CS where user has spent time, and also the offline effort spent by the user as obtained from PDs and PD servers 408A that connect to the Server. The merged User Effort Map is then downloaded back to each CS and stored in the User Effort Map database 318.

Rules and Pattern Matching Engine 314: The Rules and Pattern Matching Engine 314 maintains the list of Activities and Purposes, and the mapping rules as applicable to the user depending on the user's position and role in the organization. These mapping rules are obtained from the Organization Settings and Rules Engine 414 and maintained in the Rules and Patterns database 316. The user may edit any default mapping rule, provided it is marked as being editable, and may also add new mapping rules that relate to certain unique usage patterns for applications and artifacts. New user mappings are communicated back to the Server side Organization Rules Engine 414. The Rules and Pattern Matching Engine 314 makes the data available to the Time Analyzer 308 for mapping the user's time utilization.

Private Time Selector 330: The Private Time Selector 330 optionally enables the user to disable time tracking for a specified duration. The entire time is marked as Unaccounted and Private. The private time selector may optionally be enabled only outside of regular working hours.

Local User Interface 322: Local User Interface 322 lets the user to review time utilization and mapping to Activity and Purpose in the User Effort Map 318 for the current and recent days (typically last 7-30 days), edit mappings (if enabled) and add new mappings if required. The Local User Interface 322 also enables the employee to track and improve work effort. The user can view minute by minute details of the captured and mapped time for past few days, and higher level analysis such as trends and reports of time utilization on work across Purposes and Activities, Work Patterns such as work focus through uninterrupted time on important activities, distractions, breaks taken and work units completed. The user can edit Activity-Purpose mappings, and utilize the trends to ensure adequate and right quality of effort, benchmark current performance against goals, improve productivity and optimize work-life balance.

Gamification Module 324: The Gamification Module 324 is designed to encourage the user to improve work habits by setting challenges related to work focus and minimizing distractions, awarding performance points, badges for consistent performance, and progressive performance levels.

Server Interface 326: The Server Interface 326 provides for communication between the CS Agent 300 and the Server 400. The Server Interface 326 enables download of valid Purposes and Activities, default mapping rules, goals and alerts, and User Effort Map from the Server 400. The CS Effort Map, new user mapping rules and unmapped applications and websites are also uploaded to the Server 400 through this interface.

User Identifier (not shown in figures): The User Identifier cooperates with the CS to identify a user by his/her unique login ID available with the CS. The User Identifier is further configured to prompt the user for the ID in case a neutral login is being used by more than one user.

Comparator (not shown in figures): The Comparator cooperates with the time tracker 306 to receive the marked offline slots for a user. The comparator further compares the scheduled engagements, meetings, calls, lab work, travel time and remote visits of the user, which are obtained from the user's calendar on the CS and from local Presence Devices (PDs) such as smartphone with GPS, that are connectable to or a part of the CS, with the duration corresponding to the offline slots marked for the user.

Logger (not shown in figures): The Logger cooperates with the time tracker 306 and is configured to maintain a consolidated and sequential log of user's online and offline slots.

Interface Engine (not shown in figures): The Interface Engine periodically reviews the final User Effort Map 318. The Interface Engine determines the work patterns of the user, such as leaves taken, work done on holidays, desk or supervisory or travel oriented job, shift timings, variable work week, work focus, distractions and completed work units.

The CS Agent 300 and the Server 400 communicate over the network 250 which can be the Internet or the local area network of the organization.

According to the first aspect, the OS Collector 302 is configured to run in background of user's CS while collecting events related to the user's interaction with the CS, identity of the current active application window, and artifacts related to said application. Further, according to the first aspect, the OS Collector 302 is interfaced with an operating system that is selected from a group consisting of a desktop operating system, a laptop operating system, a mobile phone operating system, and an electronic notebook (tablet) operating system. The OS Collector 302 continuously samples and stores the employee's current active application running on the CS and its associated artifacts such as files, folders and web-links. If multiple applications are open, the OS Collector automatically tracks only the user's active window. Further, if the user is inactive, that is, there is no movement of any physical input device such as keyboard, mouse or touch screen, for a pre-determined time, typically 5 minutes, the time thereafter is marked as ‘away from PC’ time (also referred to as ‘offline’) until the user returns to the CS. Any programmatically simulated input device movement, as is the case with test automation software, will be ignored by the CS Agent.

The Time Tracker 306 receives the collected data from the OS Collector 302 and arranges the sampled data chronologically. The Time Tracker 306 analyzes and aggregates online time to provide a table about total time on each unique application and each artifact for a calendar day. The Time Tracker 306 prepares a similar table of contiguous offline time slots for the day. The Time Tracker 306 can be further configured to interface with the CS's Operating System 304 to collect the employee's offline work schedule from calendaring applications such as Microsoft Outlook, Lotus Notes, and Google Calendar. The Time Tracker 306 may obtain additional inputs from PDs that interface with the CS regarding other offline work (example, a smartphone CS that also identifies time on calls, travel and remote visits). The offline time overlapping with the calendar and PD inputs are then annotated with details such as appointment title, call contacts, travel and visit location.

The Time Analyzer 308 takes the output of the Time Tracker 306 and maps the time slots to Activity and Purpose based on mapping rules for the user provide by the Rules and Pattern Matching Engine 314. Activity relates to the nature of work such as Engineering, Documentation, Communication, Meetings, Calls, Travel, and so on, and is typically related to the online application being used or the nature of the offline work. Purpose is the objective of the work, and will either be a project or function that the user is assigned to, non-project corporate work, or personal time. The resulting output of the Time Analyzer 308 is stored in the CS Effort Map database 310.

In today's 24×7 work environment, there can be several variations from a single user and single CS theme. For example, a single user may work on different CS concurrently (home and work PCs, smartphones, tablets), multiple users may share the same CS, and several users may share a server possibly with a common login ID. The system envisaged by the present disclosure supports multi-user and multi-CS modes of operation. CS agents log each user's data on shared systems, provided each user logs in to the CS with one or more valid IDs in the user's record on the Server. The typical IDs are the employee's sign-on ID (one or more, such as for the workgroup, company's network domain, and customer's network domain), employee identification number, phone extension, mobile number, email ID, and so on. If multiple users log into a shared CS using a common ID, the CS Agent prompts for proper identification of the new user for correct allocation of the user's time utilization.

Each user therefore may have more than one Effort Map corresponding to the different CS and offline PD effort data. The CS Effort Map is uploaded to the Server 400 by the CS Effort Map Unit 312 using the Server Interface 326. At the Server, the Server Effort Map Unit 408 prepares a combined Effort Map for each user by merging all CS Effort Maps having the user's time data. The merging also includes the offline PD Effort Map relating to calls, visits to specific office areas such as labs, work related travel and meetings, and so on, as obtained from various PDs and PD servers. The engagements, meeting requests, appointments, and call and location records of the user are compared with the occurrence and duration of the offline time, whereupon the detected duration of the offline time is correctly updated. The composite User Effort Map is downloaded back to the CS Agent 300. Thus, an accurate and comprehensive view of the user's online and offline effort is obtained at each CS and stored into the User Effort Map database 318.

It is only by way of example and illustration that the above description mentions that each user's offline time is determined based on calendaring information on the CS and presence information from PDs and PD servers connected to the Server. In some embodiments, the calendaring information for some or all users may be obtained at the Server by connecting to the organization's Calendar servers. Similarly, in embodiments, a CS such as smartphone and tablet may itself have or obtain data about user time on calls, travel and remote meetings.

In accordance with the first aspect, the Time Analyzer 308 on the CS Agent of the present disclosure uses intelligent rules to map time spent by the employees to Activities and Purposes. The rules are derived from the Rules and Pattern Matching Engine 314. The resulting output is stored in the CS Effort Map database 310.

The Rules and Pattern Matching Engine 314 obtains user specific list of Activities and Purposes, and the application and offline mapping rules from the Server side Organization Settings and Rules Engine 416.

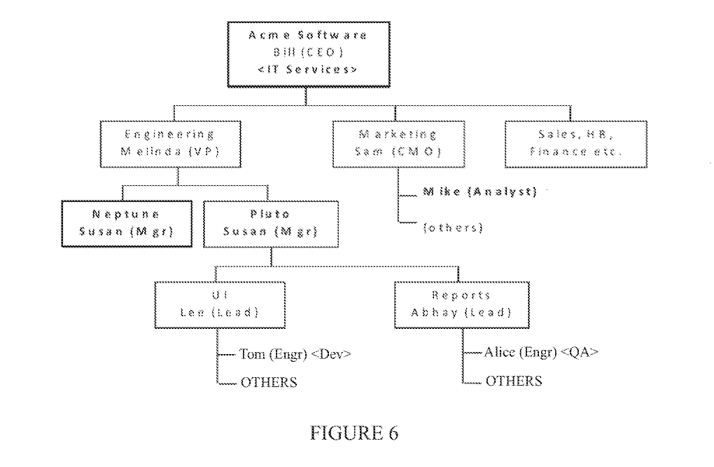

The discussion below provides a detailed description of how mapping rules get progressively more refined and comprehensive based on new information that becomes available at the two engines—Server side Organization Settings and Rules Engine 416 and the Rules and Pattern Matching Engine 314 on each CS. FIG. 6 illustrates a representative organization (an IT Services company called Acme Software), and indicates its hierarchy consisting of various sub-units and users, along with typical attributes.

The Server side Organization Settings and Rules Engine 416 configures a master list of Activities and Purposes based on the organization profile. The master list of Activities for Acme Software is selected appropriately based on its primary business attribute of being an IT Services company. If required, the Acme Software administrator can edit or add to this default list:
Online Activities: Planning, Design, Programming, Test/QA, Communication, Documentation, Marketing
Offline Activities: Meetings, Calls, Business Visits

At the Server, the Organization Sync Agent 404 automatically obtains the organization hierarchy, user list, and business attributes of organization sub-units and users, from the Human Resources (HR) or Enterprise Resource Planning (ERP) system. The user's Purposes will typically be the project or function or group that they belong to in the organization hierarchy. In the example of FIG. 6, Susan heads two projects called Pluto and Neptune. Tom is a development engineer in the Pluto UI team, and Alice is a QA engineer in the Pluto Reports team. Mike is an analyst in the Marketing team. The Purposes for them are respectively Pluto and Neptune (Susan), UI (Tom), Reports (Alice) and Marketing (Mike).

At the Organization Settings and Rules Engine 416, all work related applications and websites of interest to the organization are mapped to a default Activity and Purpose. Default mappings also apply to offline time captured from calendaring tools on the CS Agent 300 such as Microsoft Outlook, Lotus Notes and Google Meeting, and as obtained on the Server 400 from PDs and PD servers. Default offline Activity can be meetings, calls, work travel, lab work and so on.

In the example of FIG. 6, online applications such as Outlook and Google Chat are marked to Communication, MS-Office programs such as Word and Excel to Documentation, tools like Visual Studio and Eclipse to Programming, and others like Bugzilla and QTP to Testing. In the case of offline time, the source is important. Hence, user time obtained from calendaring tools will be marked to Meetings, time noted on phone calls as per smartphone or PABX server or IP phone server will be tagged to Calls, and travel time to business destinations as sourced from GPS based smartphone will be inferred as being for Travel. Swipe card entry/exit information can be used to determine and mark user's time in a lab being used by the Pluto team, to ‘Lab Work’ as the specific Activity and ‘Pluto’ as the Purpose.

In embodiments, the mapping rules for the same application, website or offline work, may vary depending on the sub-unit and employee role. In the example of FIG. 6, time spent by QA engineers like Alice on Visual Studio and Eclipse will be marked to Testing instead of the default of Programming for development engineers. Similarly, time spent on social networks such as Facebook and Twitter will be marked to Marketing for Tom. Facebook time will not have any default marking for Susan, Tom and Alice, which means that their time on Facebook will automatically get tagged as being for personal purpose.

In some embodiments, the central mapping rules can be changed by intermediate managers, whereby the revised mapping rule applies to employees and sub-units reporting to that manager.

Each mapping rule assigns a specific Activity, which represents the most common use of the application, to that application. In the case of Purpose, the mapping can be made to a common Purpose such as ‘Corporate’ (representing any common company related work such as filing expense reports and leave applications), or to a generic one referred to as ‘Current Purpose’. The latter assignment ensures that this generic mapping on the Organization Settings and Rules Engine 416 defaults to that particular user's currently assigned project or function in the CS Agent 300 side Rules and Pattern Matching Engine 314. An employee may be simultaneously assigned to more than one project/function. In such a case too, the system envisaged by the present disclosure allows the user to change the ‘Current Purpose’ at any time via the CS Agent local User Interface 322, as a result of which the specific mapping from that time onwards automatically gets mapped to the project/function that the user is working on. In the example, if Susan had been working on Pluto for a while and now switches to Neptune, she can change the Current Purpose to be Neptune.

A mapping rule can be marked as being non-editable, in which case it applies uniformly throughout the organization and cannot be changed.

The local User Interface 322 on the CS allows the user to review current time utilization and mappings by accessing the User Effort Map database 318. In some embodiments, the rules that are marked as being editable by the user can be modified by an employee, for example in case of non-standard use of an application or different uses of the application based on the artifacts (files, folders and websites) being worked on.

In some embodiments, the user may define mapping rules that are based on the names or partial names of artifacts such as folders, files and web links. In the case of offline time, the patterns may relate to specific people, phone numbers, and locations. The user can map such partial or full artifact names to a default Purpose and Activity. Thereafter, future instances of the artifact are identified by pattern matching, and mapped automatically to the corresponding default Purpose and Activity. For example, Susan may mark time spent on a particular Excel file PlutoPlan.xls as being for Planning, rather than the generic Documentation, and further specify that any file with the text ‘Pluto’ or ‘Neptune’ in it be marked to Planning and respectively Pluto and Neptune as the purpose.

In some embodiments, the organization or intermediate manager can also set mappings based on artifacts such as common folders or phone numbers and locations. For example, if a project team follows a particular nomenclature for naming folders associated with a particular project then, all users in that project inherit the rules that map the named folders to default Activity and Purpose. Similarly, offline work in labs and conference rooms may default to a specific Activity and Purpose.

The user side mapping changes are remembered by the CS Agent unless the user explicitly suggests otherwise. In some embodiments, these mapping changes are visible to immediate supervisors, senior supervisors, and executive staff in the organization.

Embodiments of the method provide for an ‘automated’ mode of deployment. Users and managers are not permitted to edit any mapping rule, both for online and offline time slots. All rules are set as non-editable in the Organization Settings and Rules Engine 416. In one variation of the embodiment, users can only create new rules to mark any unmapped applications and websites that they used from the default ‘Private’ to work. They cannot change existing rules regarding online and offline work. In another variation, users can change rules for editable online applications and websites, but not for offline work.

In accordance with the present disclosure, the Organization Settings and Rules Engine 416 can specify whether new applications and websites used by an employee that do not have any default mapping, should get marked by the CS Time Analyzer 308 to Activity as Unaccounted and Purpose as Private or any other Purpose. Mapping unknown applications and time to Private ensures greater protection of the employee's privacy. User time marked to Private is not visible to the organization unless the user explicitly changes the mapping to work. In the example, time spent by Alice on Facebook and Twitter is marked as Private. Mike's time on Facebook the other hand is being shown as Marketing time. He may also change his default for Twitter to Marketing if it is being used for work.

Time on new unmapped applications and websites is communicated by the Server interface 326 on each CS Agent back to the Organization Settings and Rules Engine 416 on the Server. This is aggregated across all users and displayed to the Administrator but with user names removed to preserve privacy, thereby allowing more default rules to be created if these are work applications and websites. Thus, more and more work effort can be accurately captured and mapped without requiring any user input.

In some embodiments, the Organization Settings and Rules Engine 416 on the Server employs team intelligence. For instance, if a user is part of a team, any assignment by a team member becomes a hint or the actual assignment for a new application and artifact combination until and unless the user changes the mapping. Thus, proper mapping by one user in the team reduces time spent on Activity and Purpose mappings by other team members.

In some embodiments, when a new project is started, the mapping of application and artifacts to Activity of a previous project can be taken as a reference for the new project, thus leading to an ever increasing accumulation of intelligence related to mappings.

In some embodiments, especially in large organizations, the Activity List can be multi-level in order to support the diverse nature of work being done in different parts of the enterprise. Each level in the enterprise can mark off the Activities that apply to them, and the next level managers can further short list the applicable Activities. This ensures that at individual employee level, the Activity list is manageable and confirms to the employee's role.

The multi-level Activity list can be further customized for the available roles or sub-units in the organization. In such an embodiment, multiple default mapping rules can be created for the same application, to match its common use in various sub-units or employee roles. At an individual employee level, typically only one applicable rule will exist. If more than one is available due to the employee's varied roles, then the most appropriate one is selected based on the related artifact, user's current purpose or some other criteria like the mapping of other team members.

Some embodiments of the present disclosure include a multi-level Purpose tree for enabling fine-grained effort tracking at project, module, or task level. Individual employees may be assigned to one or more tasks in different modules and even projects, for example. To distinguish work on each task, the employee must update the Current Purpose on the CS whenever there is a switch to a new task. A multi-level Purpose hierarchy enables a business unit head to track effort on projects, while project managers can get effort measurement on various modules, and module leaders can get insights into effort spent on features and tasks.

In some embodiments, the present disclosure provides for additional individual privacy with a Private Time Selector 330, which optionally enables the user to disable time tracking for a specified duration. The entire time is marked as Unaccounted and Private. The private time selector may optionally be enabled only outside of regular working hours.

The system envisaged by the present disclosure has a Local User Interface 322 on each CS that processes the User Effort Map database 318, and presents the results in a meaningful way for the employee on the CS screen. The Local User Interface adapts the presentation to match the screen viewing capability of the CS, which may range from a large screen available on desktops and laptops, to the small screen area on a tablet and smartphone. The employee can privately view the personal and work related time utilization, mapped to Activity and Purpose.

The Local User Interface 322 provides a lot of detailed information about high level work trends, with the ability to drill down to minute by minute accounting of time spent on personal and work related activities. This is typically available for the past 7-30 days. Trends displayed on the local User Interface 322 include first Activity and last Activity time (online or offline), first online and last online time, total time in between, online and offline time, and breakup on work and personal. Work Time trends and reports across Purposes, Activities, Applications and artifacts are available for each day, or on weekly basis.

The Local User Interface 322 also infers and reports on Work Patterns of the user such as leaves taken, work done on holidays, shift timings, non-standard and variable work week, gap between time in office and time on work, completed work units and so on. It can infer that the user is a desk worker with mostly online work time on one or more CS, or does supervisory work involving online and offline work, or is a travel oriented worker spending time mostly offline and away from office. It can determine work behavior that can influence overall productivity such as the average and maximum uninterrupted focus time on important activities, work units, number of distractions, and breaks taken from the CS for desk workers. For supervisory and travel oriented workers, the statistics related to average and maximum time on meetings, business calls, and travel time to a customer site, can be useful.

In some embodiments, the CS Agent 300 may store user trends for a much longer period—months and longer. The trends provided on the Local User Interface 322 are more detailed, available for example on monthly and cumulative basis, and with the ability to compare between different time periods.

Since the Local User Interface 322 is local on the CS, there is no requirement for the CS Agent 300 to be connected to the Server 400 when the user wants to review and edit the work effort information. The availability of the Local User Interface 322 promotes the sense of individual privacy and lets the user to review and update work effort, mapping rules, and switch the current purpose, without requiring Server access. While the user gets a detailed view of the work effort on the CS, managers can typically only view the employee's high level work data (without personal time details) on the Server 400. In some embodiments, managers do not have visibility into artifacts such as files, folders and websites. In other embodiments, the user's data is available only in terms of daily or weekly or monthly totals on the Server. Finally, in one embodiment (‘anonymous’ mode), there is no individual level access for managers.

In some embodiments, the Local User Interface 322 lets the user edit the mappings, provided the rule is editable at user level. Unmapped applications, websites, and unaccounted offline time, which normally default to ‘Private’ in order to protect the user's privacy, can be changed to reflect the work done. This will ensure that the user's work effort gets recognized in the information that is made available to the organization on the Server 400.

As per the recent trends visible in the Local User Interface 322, if the user finds that the work effort is not sufficient, the employee can start ensuring more time on work. Similarly, the employee can verify that work time is being spent adequately on the core Activities. The work can improve habits by increasing work focus and reducing number of breaks taken, reducing average length of meetings and business calls and so on.

In some embodiments, the user can be guided for improved performance by setting one or more goals regarding minimum work time, online work time, time on specific purpose, activity, application or artifact, and so on. The goals are set from the Server 400 for the organization or by a manager, and may change periodically as the work shifts from one phase to another. The Local User Interface 322 compares user's current performance against goals, and generates an alert if required for the individual. The user can then make the necessary adjustments to meet the desired goals.

In some embodiments, the method provides a User Gamification Module 324 to encourage improved work habits by setting challenges related to work focus and minimizing distractions. For example, productivity is known to increase if an employee spends sustained burst of online work on an important task for at least 20-30 minutes without switching to emails and taking an offline break. Another area of improvement is work-life balance, wherein the user delivers enough work effort during office hours and limits non-work time. The user can choose a challenge on any of the above aspects, and the Gamification Module guides the user towards meeting the challenge. Performance points are awarded based on achievement, which lead to a badge when a certain number of points have accumulated. The challenge complexity can be increased progressively. The Gamification Module 324 interfaces to the employee through the Local User Interface 322.

The Server Interface 326 provides for communication between the CS Agent 300 and the Server 400. The Server Interface 326 periodically downloads the list of valid Purposes and Activities, default mapping rules, and goals and alerts for the user from the Server 400. These are made available to the relevant components in the CS Agent 300. Typically, the downloaded information only needs to reflect the changes since the last instance. In a similar manner, any new user mapping rules and unmapped applications and websites are also uploaded to the Server through this interface.

The CS Effort Map Unit 312 utilizes the Server Interface 326 to upload the CS Effort Map to the Server 400. After creating the merged User Effort Map, the Server 400 coordinates with the Server Interface 326 to download it into the User Effort Map database 318.

In most embodiments, the communication between the Server Interface 326 and Server 400 is every half working day (3-4 hours), since the objective is not to track employees minutely but to determine overall work effort to achieve improvements and efficiency gains. In some embodiments, where it is necessary to track employees in real time, the communication can be every few minutes. The communication is optimized to only transfer the changes since the last exchange, and also transfer lower priority items less frequently.

If the Server is inaccessible for any reason, the CS Agent 300 continues to function with the existing data, and resumes the exchange of information once server connectivity is restored.

As noted previously, FIG. 2 shows a schematic 200 of the system to measure, aggregate and analyze exact effort and time productivity. The system includes at least one CS Agent per employee cooperating with at least one Server, said CS Agent adapted to generate exact effort data for a user. The first aspect of the present disclosure related to the CS Agent 300 and its components were discussed above.

According to the second aspect of the present disclosure, it includes at least one Server 400 configured to collect effort data from all employees, which is then aggregated and analyzed across the enterprise hierarchy, thereby providing a powerful platform for organization wide effort and capacity optimization. Along with employee work effort, the system envisaged by the present disclosure collects the organization hierarchy information and attributes pertaining to sub-units from various existing organization application data stores. It configures a master list of Activities and Purposes, derived from the organization hierarchy (which represents projects and functions) and business attributes (which determine the relevant Activities for a particular type of organization and its sub-units). Default rules for mapping online and offline time slots to Activities and Purposes are also configured, which may be rules adapted for organization sub-units based on their business attributes and further adapted for each user based on his or her position in the sub-unit hierarchy and the user's role therein. The system envisaged by the present disclosure computes the per-employee Daily Average Work Patterns and creates an n-dimensional effort data cube in which effort data of employees is aggregated and rolled up as per the organization hierarchy. It facilitates views at each level of the organization hierarchy across multiple dimensions such as Purpose, Activity, applications, projects and functions, artifacts, and business attributes such as employee levels, roles, skills, locations, verticals, technologies, and cost centers. It becomes possible to selectively filter and drill down to generate discrete effort data at individual and sub-unit level, subject to the user's role in the organization hierarchy and permitted access rights. Administrative controls are provided to the organization to ensure that employee data visibility and granularity can be restricted as per the privacy requirements, legal or cultural.

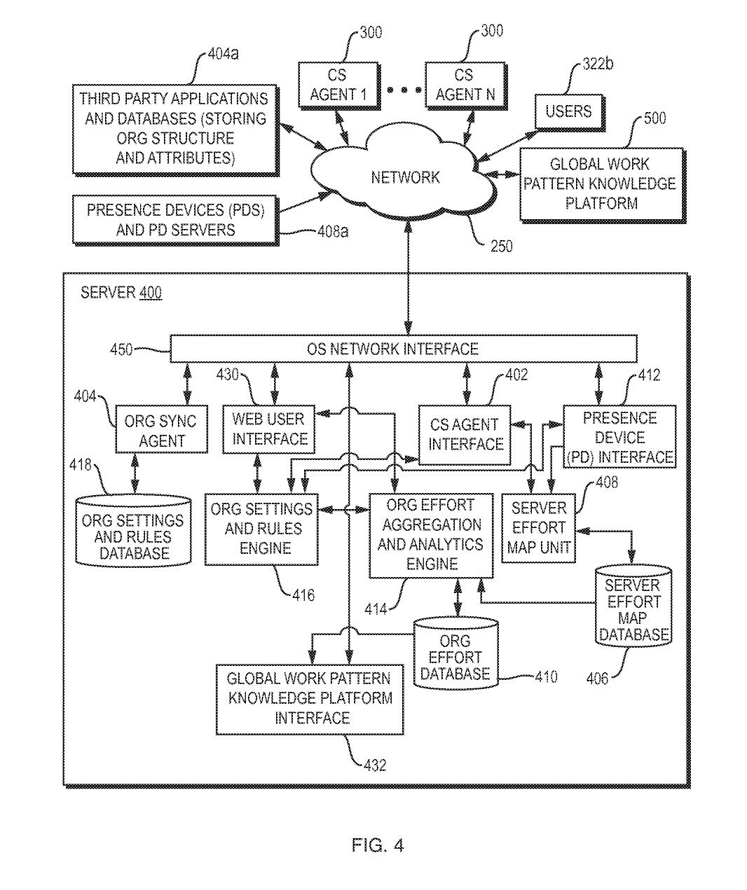

FIG. 4 is a schematic of the Server 400 and its components, as described further below:

CS Agent Interface 402: The CS Agent Interface 402 handles all the communication with the Server Interface 326 on each CS. It enables upload of valid Purposes and Activities, default mapping rules, goals and alerts, and User Effort Map to each individual CS Agent 300. The CS Effort Map, new user mapping rules and unmapped applications and websites are also downloaded to the CS Agent 300 through this interface.

Organization Sync Agent 404: The Organization Sync Agent 404 consists of collection logic and a Data Exchange framework for shared database and programmatic interface with third party applications and database servers 404A. It interfaces to one or more existing organization applications or data stores to periodically collect and update the list of valid users and organization hierarchy that map each user to one or more organization units, wherein users can be grouped along multiple hierarchies, for example corresponding to functions, services lines and locations. It also collects business attributes qualifying each employee and organization sub-unit which may be available from one or more existing organization application data stores. The gathered information about the organization hierarchy, attributes and users is maintained as part of the Organization Settings and Rules database 418. An open Data Exchange framework is defined that enables the external application data stores (such as HR and ERP applications and databases) to present their organization structure and business attributes data in a format that can be imported readily by the organization sync agent 404. Further, after the first import, the organization sync agent 404 stays consistent with the organization structure and attributes, by regularly importing the latest versions, comparing with its own previous copy, and applying all subsequent changes.

Server Effort Map Unit 408: The Server Effort Map Unit 408 receives the CS Effort Map from every CS of each user on regular basis over the CS Agent Interface 402. It also obtains the Offline Effort Map of all the users from the PD Interface 412. The Server Effort Map Unit 408 merges these multiple Effort Maps to generate a consolidated User Effort Map for every user. This aggregate data for all users is stored in a Server Effort Map database 406. The CS Agent Interface 402 downloads the merged User Effort Map back to each CS for every user.

PD Interface 412: The PD Interface 412 connects to various PDs and PD servers 408A that connect to the Server, and obtains information about the user's offline time spent on calls, visits to specific office areas such as labs, work related travel, remote meetings, and so on. It prepares an Offline Effort Map for each user and makes it available to the Server Effort Map Unit 408. The PD Interface obtains information about offline mapping rules from the Organization Settings and Rules Engine 416.

Organization Effort Aggregation and Analytics Engine 414: The Organization Effort Aggregation and Analytics Engine 414 accesses the daily effort of each individual employee from the Server Effort Map database 406, computes a per-employee Daily Average of Work Pattern, and performs the aggregation, averaging and analytics of individual effort across the entire organization hierarchy (which may be single level or multiple as in the case of matrix organizations) and business attributes collected at the Server, and stores the results in an n-dimensional Organization Effort database 410. The Organization Effort Aggregation and Analytics Engine 414 enables generation of trends, reports, goal compliance, alerts and rewards notifications responsive to said exact effort data across Purposes, Activities, applications, artifacts and organization attributes.

Organization Settings and Rules Engine 416: Organization Settings and Rules Engine 416 keeps track of the organization structure, users, access rights, privacy filters, various configuration parameters for the organization, master list of Activities and Purposes further adapted for each user, and rules related to mapping of online applications and offline PD data to Activity and Purpose as defined for each user, team and the like. These settings and rules are stored in the Organization Settings and Rules database 418. Web User Interface 430: Web User Interface 430 enables employees to view trends, reports, alerts, and administration functions using Internet Browser or standalone web applications. This interface is also available to a central administrator and managers for editing the organization structure, Activity and Purpose list, rules and settings.

Global Work Pattern Knowledge Platform Interface 432: The Global Work Pattern Knowledge Platform Interface 432 lets a participating organization contribute their high level Work Pattern analytics and trends to a Global Work Pattern Knowledge Platform 400, along with a high level profile of the organization regarding its size, industry, vertical, and so on. In turn, the organization can obtain reports that rate its performance and standing relative to peer organizations along selected profile criteria.

In accordance with the present disclosure, the Server Effort Map Unit 408 is the module in which the various Effort Maps of each user, such as from one or more CS belonging to the user, servers shared by multiple users, and the offline PD Effort Map, are merged to generate a final User Effort Map for every user. Effort Maps of all users are stored in the Server Effort Map database 406.

In most embodiments, the PD Interface 412 periodically obtains or receives information about the user's offline time from various PDs and PD servers. For example, business calls made from user extensions can be sourced from EPABX and VOIP server logs, and directly from user mobile phones. Time spent in specific office areas based on swipe and biometric devices at office entry/exit points, labs, conference rooms, can indicate the work timings and nature of work. Location detectors, GPS and smartphones can be used to identify work related travel and time spent in remote meetings at customer and vendor offices. The PD Interface 412 prepares an Offline Effort Map for each user and makes it available to the Server Effort Map Unit 408. The offline time is mapped to default Activity and Purpose as per the offline mapping rules obtained from the Organization Settings and Rules Engine 416.

In some embodiments, the PD Interface 412 may also obtain calendaring information for all the users by connecting directly with the organization's Calendar server, in addition to or instead of calendar inputs from each user CS 300 as discussed earlier.

In some embodiments, the PD and the CS 300 may be the same device. For example, the user's smartphone or tablets track online activity as well as calls made, travel and remote visits.

The present disclosure provides for exact effort and time productivity measurement at enterprise level by way of an Organization Sync Agent 404 to collect the list of valid users and organization hierarchy that map each user to one or more organization units, wherein users can be grouped along multiple hierarchies, for example corresponding to functions, services lines and locations. For this purpose, the Organization Sync Agent 404 interfaces to an appropriate organization application server or data store to periodically collect and update the list of valid users and organization hierarchy. This information is stored in the Organization Settings and Rules database 418.

In a few embodiments, typically in small organizations, the information related to users and hierarchy may be available on an Excel or similar file and can be directly imported. In other embodiments, the Organization Sync Agent 404 has to be configured and adapted to source the information automatically from the ERP application or database, and subsequently to maintain its consistency by updating as per the changes made in the ERP.

In some embodiments, the Organization Sync Agent 404 also collects business attributes qualifying each employee and organization sub-unit (such as roles, skills, compensation for employees, and verticals, technologies, cost and profit centers for sub-units), that may be available from one or more existing organization application data stores (such as HR and ERP applications and databases). This information too is maintained in the Organization Settings and Rules database 418.

In accordance with the present disclosure, the Organization Settings and Rules Engine 416, along with the Organization Settings and Rules database 418, maintains a list of allowed privileges and access rights that regulate the ability of each user and manager to access the effort data based on their position and role. An organization specific list of Activities and Purposes can be derived from the organization hierarchy (which represents projects and functions) and business attributes (which determine the relevant Activities for a particular type of organization and its sub-units). This can be a single or multi-level Activity and Purpose master list (not shown in figures) from which a subset of Activities and Purposes are assigned at various organizational levels, which can be further edited by the respective managers subject to access and permission rights. The Rules Engine 416 defines the rules for mapping of time on various online applications and offline work such as meetings, business calls, lab work, travel, to the default Activity and Purpose, which can be further modified at manager level and ultimately by each user down the organization hierarchy. This has been described in detail while covering the functionality of the Rules and Pattern Matching Engine 314 on the CS Agent 300. Further, the Organization Settings and Rules database 418 stores various configuration parameters for the organization such as locations, public holidays, work week, roles and their privilege levels and view access rights, data privacy requirements regarding individual data visibility, options to enable anonymous and self-improvement modes, blocking of file and URL information, frequency of user effort map data update, and so on.

The Organization Effort Aggregation and Analytics Engine 414 accesses the per-user Effort Maps from the Server Effort Map database 406, and performs aggregation, averaging and analytics of individual effort across the entire organization hierarchy (which may be single level or multiple as in the case of matrix organizations) available from the Organization Settings and Rules database 418. It produces trends, reports, goal compliance, alerts and rewards notifications responsive to said exact effort data across Purposes, Activities, applications, artifacts and business attributes. The analysis results are stored in the n-dimensional Organization Effort database 410. The analytics engine is also available to users for defining and generating custom reports.

The systems and methods of present disclosure support extensive analytics. The Organization Effort Aggregation and Analytics Engine 414 derives a per-employee Daily Average of Work Pattern. This is a powerful metric that facilitates meaningful and direct comparisons between any two or more organization sub-units of any type, including individual employees. Various trends and reports are available to compare the Average Daily Productive Time across various Purposes, Activities, applications, artifacts, online and offline time distribution, work focus, breaks taken, capacity utilization and so on. The reports and trends are available on daily, weekly, monthly or cumulative basis over a specified time range, or during the project or organization lifecycle phases. The differences in the trends between the Top 20%, Middle 60% and Last 20% of organization sub-units can also be viewed, thereby encouraging others to emulate the performance of the Top 20%.

In accordance with the present disclosure, the per-employee Daily Average of Work Pattern is computed for a requested organization sub-unit for the specified time range, by aggregating the Work Pattern of each employee in the sub-unit for every calendar day in the duration of interest, and dividing this by the sum of actual working days for each employee in the said duration. Determining exact working days requires inferring and accounting for the various complexities such as whether each employee joined or left the sub-unit during the applicable period, any work was done for some time for other sub-units, holidays and vacations taken, if any work was done when on holiday or vacation, public holidays at each user's location, and employee role—whether desk job or travel oriented work, changing shift timings, fixed or variable work week, and so on.

In most embodiments, the underlying analytics engine is also made available to user for definition and generation of custom reports by selecting the parameters to be viewed and compared against, filters for selecting a subset from a range of the parameters, in which the parameter refers to any data item that is automatically tracked (for example online and offline time, applications, files, folders, websites, business calls, travel), mapped (such as Activities, Purposes), and collected from existing organization application data stores (such as users, organization sub-units, projects and functions, and business attributes such as employee levels, roles, skills, locations, verticals, technologies, cost centers), along with the ability for statistical analysis based on totals, averages, maximum and minimum values, standard deviations and others. The analytics engine operates on the information stored in the n-dimensional Organization Effort database 410.

In some embodiments, the open Data Exchange framework in the Organization Sync Agent 404 can be extended for sharing data with third party applications for project management, performance tracking, HR systems for appraisals and vacation reports, engineering software for quality, finance for costing and budgeting, hardware and software resource management and the like. Such information sharing from/to the third party applications leads to more accurate and insightful reporting on performance, quality, people capability, project costing and resource usage.

The system envisaged by the present disclosure provides for a Web User Interface 430 that is accessed using any standard internet browser or standalone web applications. It enables users to view trends, reports, set goals, alerts, goal compliance, and perform administrative functions. Depending on the employee's role and position in the organization hierarchy, and as per permitted access rights, the user can view data at a certain level, and then selectively filter and drill down to generate and review discrete effort data at the level of sub-unit and individual employees.

The reports generated by the system of the present disclosure give employees the ability to improve their work-life balance, focus on key activities, avoid distractions, and overall deliver the expected work effort. Managers can reduce micro-management and spend more time on planning and strategy, since team effort can now be readily tracked. They can verify that Daily Average work time is reasonable, and that the team is sufficiently engaged in the core activities required in that period. They can assess how the middle 60% and Last 20% are faring relative to the Top 20%. They can analyze historical data for root cause analysis of delays and quality issues, and improve future delivery by identifying the current gaps and proactively suggesting required improvements.

Senior executive management can get precise insights into effort spent on revenue earning work versus other tasks. Capacity utilization reports can be used to optimize staffing. Stress and burnout can be reduced by identifying teams and projects where there is sustained over-utilization. Teams displaying low capacity utilization can increase their effort, leading to better quality results and on-time delivery. Profitability can increase in teams that are performing well but have excess capacity, since some of the employees can be re-assigned to new projects. Embodiments of the disclosure also provide detailed capacity breakup by verticals, technologies, projects, functions, initiatives, locations, employee levels, and roles. The present disclosure therefore provides a powerful tool that can boost overall revenue and profitability by plugging wasteful effort and reducing under-utilization of capacity in every dimension of the business.

The present disclosure motivates employees and managers to try and achieve higher productivity, increased output, and improved capacity utilization, by setting improvement goals. Towards this end, some embodiments provide an alert, goals and rewards module in the Web User Interface 430. A manager can define one or more goals related to Work Patterns for an organization sub-unit or specific individuals, resulting in an alert for the concerned individual or manager or both in case the goals are not met. As an option, the alert can be used to grant reward points if the effort is a positive effort. For instance, if the productive hours for a user are less than expected hours for several days, then an alert can be raised to the individual and the manager. Further, if the productive hours have been high, the employee can be granted reward points. Similarly, if the user is not delivering required effort as agreed, such as on a specific Activity, or if the user is offline for more than required number of hours per day, week or month, then an alert is raised to the employee, and optionally for the manager.

In some embodiments, a goal compliance report can be generated indicating the number of team members who met goals and indicating any deviations from the goals. Thus, the manager need not explicitly view effort related trends and reports, or even be present in the office premises, to track progress and work engagement levels of the staff. The goal compliance report readily provides the required summary.

In some embodiments, a recognition-and-rewards system and a social platform is provided to motivate individuals and organization sub-units towards higher performance based on performance points earned on goals achieved, ascending to higher level of performance, badges based on points earned at various performance levels, regularly showcase the best Work Patterns, top performers, and award winners at individual and organization sub-unit level, and allow users to socialize personal and team achievements.

In some embodiments, the individual can set self-improvement goals that can then be tracked on regular basis.

In some embodiments, unusual Work Patterns and any recent significant positive and negative deviations for any organization sub-unit are deduced by comparing with expected trends and by comparing recent and past behavior. An exception report is generated with guidance on specific actions that can be taken to make corrections and drive improvements.

The Web User Interface 430 has an administration module that lets authorized administrators and managers to edit some of the information stored in the Organization Settings and Rules Engine 416, such as various organization parameters (locations, work week, public holidays at each location), the multi-level Purpose and Activity hierarchy, defining web applications using partial URLs that identify them, mapping of applications and PD offline to default Activity and Purpose, defining default alerts and goals, and specifying standard report templates. The administration module also lets the organization set its privacy policy regarding individual data, such as whether details or at least total time spent by users on personal work should be visible, parameters for the data filter such as whether user work related files and URLs should be visible, granularity of user data (real-time, daily, weekly, or monthly), whether access to individual time data should be blocked for selected managers, and enablement of anonymous or self-improvement modes.

In certain embodiments, where the organization structure and attributes may not be available elsewhere, an administrator can also directly add, edit and manage the list of users and the reporting hierarchy.

In some embodiments, the authorized managers have access to the administration module to re-structure their teams, select from the multi-level Activity and Purpose lists, add and edit mapping rules, and define custom reports.

According to a third aspect of the disclosure, administrative controls are provided that allow each organization to strike the desired balance between work effort visibility and respect for individual privacy. This is required since organizations have different work cultures and information security requirements, and must also comply with privacy laws in each of the countries that they operate in. The three main control parameters include marking user's private time, limiting the details of work time that are available to the organization, and restricting the ability to view individual work data.

In an embodiment, notably in industries where information security at work is paramount, the details of all the time during office hours and on office equipment is made available to the organization.

In most other embodiments though, visibility into users' personal time details is not available to the organization. It is further possible to exclude total time spent on personal activities during office hours, though the details are never available as noted earlier. Some embodiments provide the user with a private time selector with which the employee's time tracking is temporarily but completely disabled for specified duration, and the entire time is marked as Unaccounted and Private. In embodiments, wherein all work is done within the office and in fixed office hours, the time selector can permit the user's time utilization to be tracked only within the office.

In some embodiments, the details of work time visible to the organization may also be restricted. The organization has the option to block access to certain work related information, such as applications and artifacts (files, folders and websites). In a few embodiments, instead of the accurate minute by minute time utilization, the organization can reduce the resolution of the user's work data that is available at the Server from real-time to just daily, weekly, or monthly averages.

The present disclosure includes and hierarchical effort control module, wherein visibility of individual work data is as per the reporting hierarchy and according to the user's access rights. In some embodiments, only select managers are permitted to view the individual work data for their team members. In embodiments, visibility of individual effort data for senior staff (for example, directors, vice presidents, CXOs and board members) is blocked and not available to anyone in the organization.

In one embodiment, in order to comply with privacy laws of the organization or specific countries where they operate, the option of an ‘anonymous’ mode is provided. In this mode, the individual data visibility is completely blocked for the entire organization or for sub-units in certain geographies. It is possible to drill down only to team level trends provided the team has a certain minimum number of employees (so that an individual's Work Pattern cannot be guessed at).

In another embodiment, organizations can opt for complete individual privacy through a ‘self-improvement’ mode in which no user data is uploaded to the Server 400. The organization can only define the hierarchy and attributes, mapping rules, and set goals for desired Work Patterns. Productivity improvements are achieved purely through self-awareness, wherein employees track their own Work Patterns as provided on the local CS. In a further variation, an employee may voluntarily allow aspects of the Work Pattern to be uploaded to the Server anonymously, in return for being able to view the comparative trends across everyone who shared their data, and view their own relative performance. The voluntary Work Pattern sharing may be accompanied by identifying the user's profile, such as role, seniority, location, skills and so on, so that comparisons can be made with peers with a similar profile.

Typically, the employee always has full visibility to their own work and personal data on the User Interface 322 on their local CS. However, a few embodiments may not provide any local User Interface capability to employees, and all time capture and mappings are entirely automated. Select administrators and managers can view trends on the Server at team level, and optionally at individual level.

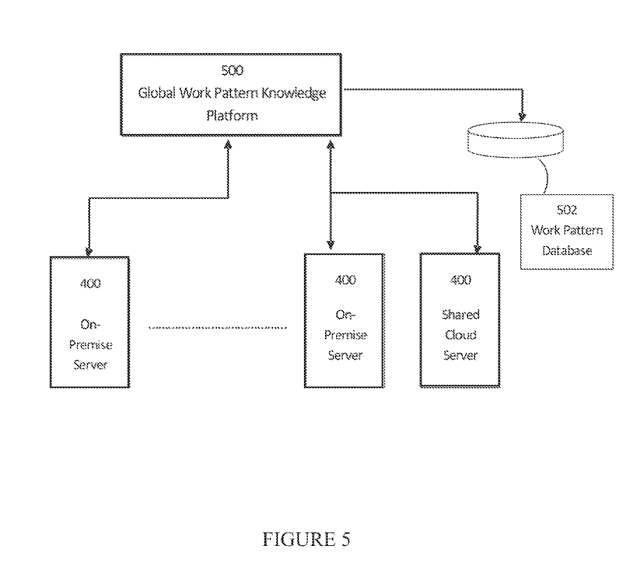

In the fourth aspect of the disclosure, as illustrated in FIG. 5 below, the disclosure specifies a Global Work Pattern Knowledge Platform 500 in which organizations across various industries, verticals, countries, and scale, can participate by contributing their Work Pattern trends and analytics at a high level while retaining anonymity, and in return get feedback on how they rank relative to peer organizations selected based on criteria of interest. The Global Work Pattern Knowledge Platform 500 may be on a separate server machine, or can be an extension to the cloud based Server which hosts all organizations that did not opt for an on-premise Server.

A Global Work Pattern Knowledge Platform Interface 432 is available on each Server 400, catering to a distinct organization. The Web User Interface 430 on the Server permits an authorized administrator to sign up to the Global Work Pattern Knowledge Platform 500 as a participating organization. A high level profile of the organization regarding its size, industry, vertical, and so on, is defined and uploaded to the Global Knowledge Platform 500. The Knowledge Platform Interface 432 on each Server 400 communicates the organization's high level Work Pattern analytics and trends based on employee and sub-org categories. In turn, the organization can obtain reports that rate its performance and standing relative to peer organizations along selected profile criteria. All comparisons involve anonymity for the participating organizations. The individual Work Pattern information along with profiles for various contributing organizations is stored in a Global Work Pattern database 502.

As described, the system envisaged by the present disclosure measures, analyzes and improves the effort and time productivity of white collar staff. The key elements of the system envisaged by the present disclosure are as follows:

The system of the present disclosure captures all the work effort which in today's environment which may be at any time during the day (24 hours) and week (7 days). These include office workers spending most of their work time on computers, and marketing and sales staff making extensive business calls and travelling to customer locations. Systems and methods have been described to track the daily time spent by employees, irrespective of whether the time is spent on one or more computing devices, or away from any computing system while in meetings, discussions, calls, lab work, travel, and remote visits.

The captured individual work effort is mapped to the organization's hierarchy and business attributes. This organization data does not have to be manually defined or configured, but is also automatically collected from existing organization application data stores. As a result, it becomes possible to identify the work patterns and trends within each sub-unit and operational dimension of the business, and hence providing a powerful platform for enterprise wide effort and capacity optimization.

The requirements of employee privacy, organization culture, and the different privacy laws of countries where the organization may operate, are taken care of through a variety of methods and systems to prevent any access to individual personal time details, and provide individual work data visibility only to the extent appropriate, including the option of voluntary sharing of work trends by employees.

Finally, the present disclosure provides a Global Work Pattern Knowledge Platform, wherein organizations across various industries, verticals, countries, and size, can participate by contributing their high level work pattern trends and analytics, and in return get feedback on their rating relative to peer organizations, with anonymity assured for all participants.

### TECHNICAL ADVANTAGES

The technical advantages of the present disclosure include the realization of the following:
providing an intelligent and highly automated system to measure, record, analyze, report and improve the work effort put into various Activities and Purposes for an organization by individuals, teams and organization sub-units assessed as per the organization hierarchy and related business attributes;
providing a system that automatically determines each employee's effort throughout the day (24 hours) and week (7 days), whether performed online on one or more computing systems (CS), and offline such as for meetings, lab work, calls, outside travel, and remote visits. This effort is mapped to Activities and Purposes relevant for the organization;
providing a system that automatically tracks the exact time spent by the employee on one or more personal CS, any CS shared with other users through a common login, and remote servers (even if the servers do not belong to the organization), by determining the user's time on the currently active application and associated artifacts such as files, folders, websites and other artifacts related to the applications;
providing a system that automatically detects whenever the user is away from any CS, and mark this time as offline time on the CS;
providing a system that merges the user's online and offline time information sourced separately from one or more CS, and PDs and PD servers, for a consolidated view of the user's time utilization on applications and related artifacts and offline on meetings, calls, lab work, travel, remote visits and so on;
providing a system that intelligently deduces and maps each online and offline time slot to the most appropriate Activity and Purpose from a hierarchy of possible Activities and Purposes assigned to the employee from a master list for the organization, based on applications and artifacts in case of online time slots, and for offline slots from information obtained from calendaring systems and various PDs (Presence Devices) and PD servers that indicate if the user was busy in meetings, calls, lab work, travel, remote visits, and so on;
providing a system that infers the Work Patterns of the user such as leaves taken, work done on holidays, desk job done mostly online on one or more CS, supervisory work involving online and offline work, travel oriented work mostly offline and away from office, shift timings, variable work week, uninterrupted work focus on important activities, number of distractions per work day and so on;
making available a system that provides the user with a local user interface on the employee's CS, which is intended for private display of user's time utilization, both personal and work related;
making available a system that provides for user side gamification and encourages improved work habits by setting challenges related to work focus and minimizing distractions, awarding performance points, badges for consistent performance, and progressive performance levels;
making available a system that provides for exact effort and time productivity measurement at organization level without any manual definition or configuration of employee groups or attributes;
making available a system that automatically collects and maintain the list of current valid users and organization hierarchy that maps each user to one or more organization units, and can be further configured to collect and maintain the business attributes (role, skills, salary, position, location) qualifying each user, and organization sub-unit (domain, vertical, cost and profit center, priority) from the organization's existing application data stores;
making available a system that configures a master list of Activities and Purposes, derived from the organization hierarchy (which represents projects and functions) and business attributes (which determine the relevant Activities for a particular type of organization and its sub-units), and said master list may be multi-level and adapted for each organization sub-unit and user;
making available a system that configures default rules for mapping online and offline time slots to Activities and Purposes, said rules adapted for organization sub-units based on their business attributes and further adapted for each user based on his or her position in the sub-unit hierarchy and the user's role therein;
extending the Data Exchange framework for shared database and programmatic interface with third party applications for project management, performance tracking, HR systems, quality, project accounting, resource management and the like;
providing a system that collects the daily effort of each individual employee, consolidates and rolls it up as per the organization hierarchy defined at the Server, and provides analytics, reports, goal compliance, alerts and rewards notifications responsive to said exact effort data across Purposes, Activities, applications, artifacts, organization hierarchy and attributes;
providing a system that derives a per-employee Daily Average of Work Pattern, as part of the built-in analytics, specifically to allow for meaningful comparison between two or more organization sub-units, irrespective of the nature of business and role;
providing a system that computes the per-employee Daily Average of Work Pattern for a requested organization sub-unit for the specified time range;
providing a system that creates an n-dimensional effort data cube and includes an analytics engine to provide for generation of custom reports by defining the parameters to be viewed and compared against, filters for selecting a subset, in which the parameters comprise any and every data item sourced, including online and offline time, applications, Activities, Purposes, artifacts, organization sub-units, organization attributes, along with ability for statistical analysis based on totals, averages, maximum and minimum values, standard deviations and others;
providing a system that enables higher productivity, increased output, and improved capacity utilization, by setting goals for greater yet reasonable effort, and more focused time on key Activities and Purposes, by highlighting the gap between current and desired performance, as well as the performance of the Top 20% at the level of organization sub-units and individual employees;
providing a system that determines under and over utilization of effort capacity at any level of the organization hierarchy or along business attributes, and thereby optimizes staffing for maximum organization efficiency and employee work-life balance;
providing a system that deduces recent positive and negative deviations in Work Patterns, and generates an exception report with suggested actions that can be taken to drive improvement; and
providing a system that protects the user privacy by not allowing any visibility into user's personal time details, optionally providing the user with a private time selector to disable employee's time tracking for specified duration, optionally blocking access to work related details such as applications and artifacts, and optionally reducing the resolution of user's work data to daily, weekly, or monthly averages instead of real-time information to make it seem less intrusive.
providing administrative capabilities to the organization to limit individual level work data visibility only to a few select senior managers, and disabling individual work data view for senior staff (above a certain designation).
providing a system that complies with privacy laws of the organization or specific countries where they operate in by providing an ‘anonymous’ mode in which individual data visibility is completely blocked, and only team level trends and reports are possible.
providing a system that includes a ‘self-improvement’ mode in which no user data is uploaded to the Server and productivity improvements are achieved at employee level through personal goal setting and self-awareness based on the Work patterns provided on the local CS.
making available a system that provides each user with a web based user interface, in addition to the local user interface, to enable access over any internet browser to long term work related trends, reports, alerts, goals, and administrative functions on the Server, for the individual's own data as well as for the teams and organization units reporting to the user.
providing a social platform that showcases the top performers and award winners at individual and organization sub-unit level, motivates gains through a recognition-and-rewards system based on goals achieved, performance points, badges, levels, and allows users to socialize personal and team achievements.
creating a Global Work Pattern Knowledge Platform in which organizations across various industries, verticals, countries, and scale, can participate by contributing their high level work pattern trends and analytics with assured anonymity, and in return get feedback on how they rate relative to peer organizations selected based on the criteria of interest.

1. A computer implemented system for measuring, aggregating and analyze the exact effort and time productivity of at least one user, said system comprising:
at least one Computing System (CS) Agent associated with at least one user accessing at least one Server, said CS Agent adapted to automatically measure and generate consolidated and exact online and offline effort data throughout the day (24 hours) and week (7 days), said CS Agent having access to:
a master list for each user containing his or her Purposes and Activities, role and business attributes, said master list automatically preconfigured at the organization level Server based on the user's role and other work related attributes; and
a rule and pattern mapping engine containing the organization settings and current user specific mapping rules for mapping applications and offline and offline slots;
a user identifier adapted to identify a user by his or her unique login ID available with the Computing System, said user identifier further configured to prompt the user for the ID in case a neutral login ID is being used by more than one user;
a time tracker having access to said CS agent and adapted to track the user's online time on a currently active user application and associated artifact (file, folder, website) from a multiplicity of open applications on the Computing System, and record the name of the active application and artifact names and duration of usage, said time tracker further adapted to mark the user's offline time slots by determining each period of inactivity time during which no movement of physical input devices such as keyboard, keypad, touchpad, and mouse of the Computing System is detected for more than a predetermined period of time;
a comparator adapted to compare scheduled engagements, meetings, calls, lab work, travel time and remote visits of said user as obtained from the user's calendar on the Computing System and from local Presence Devices (PDs) such as smartphone with GPS that are connectable to or part of the Computing System, with the duration of said offline time slots for determining the user's offline time utilization;
a logger adapted to maintain a consolidated and sequential log of user's online and offline time slots,
a time analyzer adapted to map said logs of said slots to an appropriate Activity (such as design, programming, testing, documentation, communication, meetings, calls, lab work, travel, and visits) and Purpose (assigned projects, functions and tasks) based on the mapping rules and further adapted to generate and upload an effort map of the user on said Server;
a merger, resident in the Server, said merger adapted to obtain, from all the user's CS Agents and from the Server side PD, the user's online effort map and offline effort map, said merger further adapted to merge said offline and online effort maps and generate a final user effort map and further adapted to download the final effort map back onto each of the CS Agents of the user;
an inference engine adapted to periodically receive final user effort maps and further adapted to determine Work Patterns of the user such as leaves taken, work done on holidays, desk or supervisory or travel oriented job, shift timings, variable work week, work focus, distractions, and completed work units;
a local user interface adapted to receive inputs from said inference engine and display privately to the user the Work Pattern trends for a predetermined period, and further adapted to review and edit Activity-Purpose mappings; and
a user private time selector adapted to disable a user's time tracker for specified time slots, which is marked as an Unaccounted and Private time slot.

2. The system as claimed in claim 1, wherein said server comprises:
a CS Agent interface configured to collect effort data from every Computing System for each user, wherein the effort data is in the form of an CS effort map, said effort map configured to list in a chronological order, the online and offline time for each user;
a PD interface configured to determine the offline effort map for each user by obtaining information about user's time on business calls, meetings, visits to labs and other intra-office locations, business travels, and time spent at customer/vendor locations, by interfacing with all remote presence devices and PD servers;
a server effort map unit configured to merge said CS effort map and said offline effort map for every user, and generate a chronologically accurate and complete user effort map, said complete effort map uploaded back to every user's Computing System;
an organization sync agent configured to collect and maintain the list of current valid users and organization hierarchy that maps each user to one or more organization units, said organization sync unit further configured to collect and maintain the business attributes (role, skills, salary, position, location) qualifying each user, and organization sub-unit (domain, vertical, cost and profit center, priority) from organization application data stores;
an organization settings and rules engine adapted to configure a master list of Activities and Purposes, derived from the organization hierarchy (which represents projects and functions) and business attributes (which determine the relevant Activities for a particular type of organization and its sub-units), and said master list may be multi-level and adapted for each organization sub-unit and user, said organization settings and rules engine further adapted to configure default rules for mapping online and offline time slots to Activities and Purposes, said rules engine further configured to adapt the mapping rules for organization sub-units based on their business attributes and further adapted for each user based on his or her position in the sub-unit hierarchy and the user's role therein;
an organization effort aggregation and analytics engine configured to consolidate and roll up individual online and offline effort data as per the organizational hierarchy, said engine further configured to compute a per-employee daily average work pattern for each sub-unit, said engine still further configured to generate an n-dimensional effort data cube mapping individual and collective efforts of respective users as per the organizational hierarchy;
a recognition and rewards module configured to assign performance points to users based on the respective individual efforts of the users; and
a web based user interface configured to facilitate views at each level of the organization hierarchy across multiple dimensions such as purpose, activity, applications, projects, functions, artifacts and business attributes such as employee levels, roles, skills, locations, verticals, technologies, cost centers, said user interface further configured to selectively filter and drill down to generate discrete effort data.

3. The system as claimed in claim 2, wherein said web based user interface is configured to:
communicate with an internet browser and display through said internet browser the organizational trends, reports, alerts, goals and administrative functions depending upon the user's position and role in the organizational hierarchy; and
provide access to the organization effort aggregation and analytics engine for generation of user defined custom reports from said n-dimensional effort data cube.

4. The system as claimed in claim 2, wherein said organization effort aggregation and analytics engine is further configured to deduce the best working pattern, top performers at individual and organization sub-unit level, said organization effort aggregation and analytics engine further configured to determine unusual work patterns and the recent positive and negative deviations in work patterns for an organization sub-unit, said organization effort aggregation and analytics engine still further configured to generate a report including specific actions that can be undertaken to improve the efforts of the users.

5. The system as claimed in claim 1, wherein the rule and pattern mapping engine is adapted to generate the default mapping rules for mapping the online and offline time slots to Activities and Purposes, including pattern matching to deduce best fit rules, said rules and pattern mapping engine further configured to adapt the rules for users in organization sub-units based on the business attributes and further adapted based on each user's position in the sub-unit hierarchy and the user's role therein.

6. The system as claimed in claim 1, wherein said Computing System includes a user interface local to said Computing System configured to provide the respective users with private access to the corresponding online and offline effort data.

7. The system as claimed in claim 1, wherein said Computing System includes a blocker configured to:
mark all effort that is not identified as being on work related activities by the users' mapping rules as personal time;
enable each user to explicitly block any time that was marked as work by the user's mapping rules but which the user wishes to mark as personal;
block all third party access to users' personal time details;
block third party access to some of the users' work related information including applications and artifacts (files, folders and websites);
reduce the granularity of the users' work related information to a daily, weekly, or monthly average of the work patterns;
block all access to the users' effort, both work and personal, permitting each user to voluntarily disclose only specific aspects of his or her work patterns to the Server;
control third party access to individual level data by restricting the access to said individual level data based on the organizational hierarchy and as per assigned access rights; and
block individual data visibility of certain users based on their role or seniority in the organization.

8. The system as claimed in claim 1, wherein said blocker is further configured to actuate an ‘anonymous mode’ wherein the visibility of individual effort data is completely blocked for the entire organization or for sub-units in certain geographies, and trends and reports are available only up to team level provided the team has a certain minimum number of employees.

9. The system as claimed in claim 1, wherein said blocker is further configured to actuate a ‘self-improvement mode’ wherein:
no effort data is uploaded by default to the server;
productivity improvements are achieved through employee self-awareness by tracking user's own work patterns as provided on the local Computing System and by comparing against the goals set by the managers and the organization;
work patterns are uploaded anonymously to the server, in return for being able to view the comparative trends across the users who shared their respective effort data and rate one's own relative performance; and
user's profile such as role, seniority, location and skills are defined and comparisons are made with peers having a similar profile.

10. The system as claimed in claim 1, wherein said system further includes:
a global pattern knowledge platform configured to enable the participating organizations to share their high-level work pattern analytics and trends based on employee and sub-organization categories;
a profile definition module configured to enable the participating organizations to define profiles corresponding to at least their respective sizes, industry and vertical;
a report generation module configured to prepare reports rating the organization's performance and standing relative to peer organizations in accordance with the selected profile criteria.

11. The system as claimed in claim 1, wherein said CS Agent is selected from the group consisting of a computer desktop, laptop, electronic notebook, personal digital assistant, tablet, and smartphone.

12. The system as claimed in claim 1, wherein said time tracker is further configured to ignore any simulated input device or spurious movement through the robotic control of the physical devices.

13. A computer-implemented method for measuring, aggregating and analyzing the exact effort and time productivity of at least one user having access to a Computing System, said method comprising the following steps:
creating a master list comprising for every user, wherein said master list includes the user's purposes and activities and configuring said master list to reflect the user's role and other work related attributes;
storing the organization settings and mapping rules, said mapping rules being configured as per the position of the user in the organization hierarchy and role;
mapping online applications and offline slots in accordance with said stored organization settings and rules;
identifying a user by his unique login ID;
tracking said user's online time on a currently active user application and associated artifact (file, folder, and website) from a multiplicity of applications opened by said user, and recording the name of the active application and artifact names and duration of usage;
marking the user's offline time slots by determining each period of inactivity time during which no movement of physical input devices such as keyboard, keypad, touchpad and mouse of the Computing System is detected for more than a predetermined period of time;
comparing scheduled engagements, meetings, calls, lab work, travel time and remote visits of said user as obtained from the user's calendar on the Computing System and from local presence devices (PDs) such as smartphone with GPS, that are connectable to or a part of the Computing System, with the duration of said offline time slots for determining the user's offline time utilization;
maintaining, using a logger, a consolidated and sequential log of user's online and offline time slots;
mapping said logs of said slots to an appropriate activity (such as design, programming, testing, documentation, communication, meetings, calls, lab work, travel and visits) and purpose (assigned projects, functions and tasks) based on the mapping rules;
applying the mapping rules to the online application and offline slots and deducing best fit rules, and generating a list of user's online and offline time utilization log mapped to the activities and purposes constituting the offline and online effort maps for the user;
merging said user's offline and online effort maps and generate a final user effort map;
periodically receiving final user effort maps at an inference engine and determining the work patterns of the user, such as leaves taken, work done on holidays, desk or supervisory or travel oriented job, shift timings, variable work week, work focus, distractions, and completed work units;
receiving, at a local user interface, the determined work patterns and displaying privately to the user the work pattern trends for a predetermined period; and
disabling a user's time tracker for specified time slots, wherein said time slots are marked as unaccounted and private slots.

14. The method as claimed in claim 13, wherein the method further includes the following steps:
collecting effort data from every Computing System of every user, wherein the effort data is in the form of a CS effort map, said CS effort map listing in a chronological order, the online and offline time for each user;
determining the offline effort map for each user by obtaining information about the user's time on business calls, meetings, visits to labs and other intra-office locations, business travels and time spent at customer/vendor locations, by interfacing all remote presence devices (PDs) and PD servers;
merging said CS effort map and said offline effort map into a server effort map and generating a chronologically accurate and complete user effort map, and uploading said user effort map to every user's Computing System;
collecting and maintaining a list of current valid users and organization hierarchy that maps every user to one or more organization maps, and collecting and maintaining the business attributes (roles, skills, salary, position, location) qualifying each user and organization sub-unit (domain, vertical, cost and profit center, priority);
consolidating and rolling up individual online and offline effort data as per the organizational hierarchy, and computing a per-employee daily average work pattern for every sub-unit;
generating an n-dimensional effort data cube mapping individual and collective efforts of respective users as per the organizational hierarchy;
assigning performance points to users based on the individual efforts of users;
facilitating views at each level of the organization hierarchy across multiple dimensions such as purpose, activity, applications, projects, functions, artifacts and business attributes such as employee levels, roles, skills, locations, verticals, technologies, cost centers;
selectively filtering and drilling down said complete user map, to generate discrete effort data;
displaying the online effort data and offline effort data on a user interface local to the Computing System of the user;
blocking access to the user's personal time details and selectively allowing access to the user's total personal time calculated as a function of total work hours;
blocking third party access to user's work related information including the information corresponding to applications and artifacts (files, folders and websites);
controlling access to individual level data by restricting access to said individual level data based on the organization hierarchy;
blocking individual data visibility to certain users based on their respective organizational hierarchy.

15. The method as claimed in claim 13, wherein the method further includes the following steps:
displaying the organizational trends, reports, alerts, goals and administrative functions depending upon user's position and role in the organization hierarchy; and
generating user-defined custom reports from said n-dimensional effort data cube.

16. The method as claimed in 14, wherein the step of consolidating and rolling up individual online and offline effort data further includes the following steps:
deducing the best working pattern, top performers at individual and organization sub-unit level;
determining unusual work patterns and the recent positive and negative deviations in work patterns for an organization sub-unit; and
generating a report including specific actions that can be undertaken to improve the efforts of the users.

17. The method as claimed in claim 13, wherein the step of applying the organization setting includes the actuation of an ‘anonymous mode’ wherein the visibility of individual effort data is completely blocked for the entire organization or for sub-units in certain geographies, and trends and reports are available only up to team level provided the team has a certain minimum number of employees.

18. The method as claimed in claim 13, wherein the step of applying the organization setting includes the actuation of a ‘self-improvement mode’.

19. The method as claimed in claim 13, wherein the method further includes the following steps:
providing a global knowledge platform and enabling the participating organizations to share their high-level work pattern analytics and trends based on employee and sub-organization categories;
enabling the participating organizations to define profiles corresponding to their respective sizes, industry and vertical; and
preparing reports rating the organization's performance and standing, relative to peer organizations in accordance with the selected profile criteria.
